(19) United States
(12) Patent Application Publication
(10) Pub. No.: US 2015/0002852 A1
(43) Pub. Date: Jan. 1, 2015

(54) COHERENCE SCANNING INTERFEROMETRY USING PHASE SHIFTED INTERFEROMETRTY SIGNALS

(71) Applicant: Zygo Corporation, Middlefield, CT (US)

(72) Inventors: Peter J. de Groot, Middletown, CT (US); Leslie L. Deck, Middletown, CT (US)

(21) Appl. No.: 14/313,061

(22) Filed: Jun. 24, 2014

Related U.S. Application Data
(60) Provisional application No. 61/839,448, filed on Jun. 26, 2013.

(51) Int. Cl. G01B 9/02

(52) U.S. Cl. CPC G01B 9/0209
USPC 356/491; 356/450

(57) ABSTRACT

Low-coherence scanning systems and methods for operating the same include simultaneously measuring two phase-shifted interferograms corresponding to intensity patterns produced by interfering test light reflected from a test object with reference light on respective first and second detectors, in which the test light and reference light are derived from a common source. The interferograms measured by the first detector define a first set of scanning interferometry signals, and the interferograms measured by the second detector define a second set of interferometry signals corresponding to substantially the same multiple transverse locations on the test object, in which each interferometry signal in the second set is phase-shifted relative to a corresponding interferometry signal in the first set. An electronic processor processes the first set and second set of interferometry signals either independently from each other or in a combined manner to obtain information about the test object.

### CROSS-REFERENCE TO RELATED APPLICATIONS

This application claims benefit to Provisional Patent Application No. 61/839,448, filed on Jun. 26, 2013. The entire content of the provisional application is incorporated herein by reference.

### BACKGROUND

Non-contact surface characterization techniques, such as coherence scanning interferometry (CSI), are useful tools for measuring shape and surface finishes, and are particularly relevant to manufacturing industries for process development, quality control and process control. Desirable attributes of a non-contact method are short measurement time, insensitivity to environmental perturbations (vibration, acoustic noise, etc.) and high-resolution.

An advantage of CSI is that it allows for measuring surface structures that are more than one half-wavelength in surface height difference from one imaging pixel to the next, without the so-called fringe ambiguity characteristic of phase shifting interferometry (PSI). However, CSI is limited in its data acquisition speed, its scanning range, and its ability to tolerate certain types of disturbances such as vibration, mechanical scanning errors and instrument noise.

### SUMMARY

The present disclosure relates to coherence scanning interferometry using phase shifted scanning interferometry signals. Various aspects of the disclosure are summarized as follows.

In general, in a first aspect, the subject matter of the disclosure can be embodied in a low-coherence scanning interferometry method, in which method includes: for each optical path length difference (OPD) of a sequence of OPDs between test light reflected from a test object and reference light in a scanning interferometer, simultaneously measuring two phase-shifted interferograms corresponding to intensity patterns produced by interfering the test light reflected from a test object with the reference light on respective first and second detectors, in which the test light and reference light are derived from a common source and wherein the sequence of OPDs spans a range larger than the coherence length of the common source. The interferograms measured by the first detector define a first set of scanning interferometry signals corresponding to multiple transverse locations on the test object, the interferograms measured by the second detector define a second set of interferometry signals corresponding to substantially the same multiple transverse locations on the test object, in which each interferometry signal in the second set is phase-shifted relative to a corresponding interferometry signal in the first set. Every interferometry signal includes a series of intensity values corresponding to the sequence of OPDs. The method further includes using an electronic processor to process the interferometry signals to determine information about the test object with reduced sensitivity to errors, in which the electronic processer performs operations includes: i) processing the first set of interferometry signals, independently from the second set of interferometry signals, to obtain first processed information about the test object over the multiple transverse locations; ii) processing the second set of interferometry signals, independently from the first set of interferometry signals, to obtain second processed information about the test object over the multiple transverse locations; and iii) combining the first processed information with the second processed information to determine the information about the test object with the reduced sensitivity to the errors.

Implementations of the method can include one or more of the following features and/or features of other aspects. For example, in some implementations, each of the first processed information and the second processed information is independent of the OPD. The first processed information may include multiple first data values corresponding to information about the test object at different transverse locations on the test object. The second processed information may include multiple second data values corresponding to information about the test object at the same transverse locations as the first data values.

In some implementations, the first processed information is any of a relative height map, a film thickness map, or surface profile. In some implementations, the second processed information is any of a relative height map, a film thickness map, or surface profile. In some implementations, the information about the test object is any of a relative height map, a film thickness map, or surface profile.

In some implementations, the only interferometry signals processed by electronic processor are those from the interferograms measured by the first and second detectors.

In certain implementations, the phase shift between each simultaneously measured interferogram is approximately 90°.

In some implementations, the phase shift between each simultaneously measured interferogram is approximately 180°.

In certain implementations, the method includes translating a measurement scan position of the test object or a reference object relative to one another to obtain the sequence of intensity values corresponding to the sequence of OPDs, each intensity value of every interferometry signal being measured at a different measurement scan position. The different measurement scan positions may be separated by uniform scan intervals. The different measurement scan positions may be separated by non-uniform scan intervals. Successive intensity values in each of the interferometry signals may be measured at measurement scan positions alternately separated by a first scan interval and a second scan interval, the first scan interval being less than the scan second interval. The multiple intensity values for each interferometry signal of the first set of scanning interferometry signals may be measured over multiple camera frames of the first detector, and the multiple intensity values for each interferometry signal of the second set of scanning interferometry signals may be measured over multiple camera frames of the second detector. An absolute range over which the sequence of OPDs are obtained may be at least about 25 microns. A scan interval between intensity values may be at least about 3 quarters of a wavelength of the interferometry signal. A measurement scan position may be translated at a scan rate of at least about 10 micron/sec.

The method may further include modulating the test light and reference light. Modulating the test light and reference light may include periodically switching the common source from a substantially off-state to an on-state, and simultaneously measuring two phase-shifted interferograms occurring during the on-state of the common source. The first detector may include a first camera shutter and the second detector may include a second camera shutter, in which modulating the test light and reference light comprises periodically opening and closing the first camera shutter and the second camera shutter at approximately the same times, and in which simultaneously measuring two phase-shifted interferograms occurs during the opening of the first camera shutter and the second camera shutter. A camera frame-time for each detector may be greater than a length of time over which each intensity value is measured.

In some implementations, the multiple intensity values for each interferometry signal are acquired at a rate that is less than a Nyquist rate of the interferometry signal.

In some implementations, using the electronic processor to process the first set of interferometry signals and to process the second set of interferometry signals includes fitting a function to each interferometry signal, the function being parameterized by one or more parameter values. The function may be expressible as including multiple intensity values for corresponding virtual scan positions, the virtual scan positions being defined relative to the measurement scan positions, and in which, for each interferometry signal, fitting the function includes: applying a series of shifts to the virtual scan positions relative to the measurement scan positions; evaluating the function for each of the series of shifts in the virtual scan positions; and comparing a degree of similarity between each evaluated function and the corresponding interferometry signal. Evaluating the function further may include varying one or more of the parameters for each of the series of shifts in the virtual scan positions, and calculating the intensity values of the function based on the one or more varied parameters. The one or more parameter values may include a phase value, an average magnitude value, and an offset value. Comparing a degree of similarity between each evaluated function and the corresponding interferometry signal may include determining which of the series of shifts in the virtual scan positions produce an optimum fit between the function and the corresponding interferometry signal. Determining which of the series of shifts in the virtual scan positions produces the optimum fit may include applying a window function to the different measurement and virtual scan positions being evaluated. The window function may be a tapered window function. The window function may include a raised cosine function. Comparing a degree of similarity between each evaluated function and the corresponding interferometry signal may include identifying the virtual scan position and parameters of the function that produce a minimum square of the difference between the function and the corresponding interferometry signal. Comparing a degree of similarity between each evaluated function and the corresponding interferometry signal may include calculating a merit function for each of the series of shifts in the virtual scan positions, the merit function being indicative of a degree of similarity between the evaluated function and the corresponding interferometry signal. The merit function may be proportional to the square of the magnitude of the function at the virtual positions. The merit function may be inversely proportional to the minimum square difference between the function and the corresponding interferometry signal at the virtual scan positions. The virtual scan positions may be separated by uniform increments, each increment being less than a spacing between the measurement scan positions. The virtual scan positions may be separated by uniform increments, each increment being greater than a spacing between the measurement scan positions.

In some implementations, combining the first processed information and the second processed information includes averaging the first processed information and the second processed information. The first processed information may include multiple first merit functions, each first merit function being indicative of a degree of similarity between a function fitted to a corresponding interferometry signal in the first set of interferometry signals, and the second processed information including multiple second merit functions, each second merit function being indicative of a degree of similarity between a function fitted to a corresponding interferometry signal in the second set of interferometry signals.

In some implementations, providing the light beam includes providing an input beam from the common source, and separating the input beam into the test light and the reference light. The method may include: directing the test light through a first polarization filter towards the test object, and transmitting the reference light through a second polarization filter toward a reference object, in which the test light and the reference light have approximately the same intensity and opposite polarizations prior to reaching the first polarization filter and the second polarization filter, respectively, the test light and the reference light being orthogonally polarized with respect to each other after passing through the first and second polarization filters, and the test light reflects off the test object and the reference light reflects off the reference object; combining the reflected test light and the reflected reference light to provide combined light; transmitting the combined light through an optical component, in which the optical element is configured to alter a polarization state of the combined light; and directing a first portion of the combined light through a third polarization filter toward the first detector to produce the first interferogram, and directing a second portion of the combined light through a fourth polarization filter toward the second detector to produce the second interferogram.

The test light and the reference light may have the same polarization state, in which the method may include: transmitting the test light through a first optical component and through a first polarization filter so as to reflect off the test object, and receiving the reflected test light back through the first optical component and the first polarization filter, in which the first optical component is configured to alter a polarization state of the test light; transmitting the reference light through a second optical component and a second polarization filter so as to reflect off the reference object, and receiving the reflected reference light back through the second optical component and the second polarization filter, in which the second optical component is configured to alter a polarization state of the reference light; combining the reflected test light and the reflected reference light to produce combined light; and directing a first portion of the combined light through a third polarization filter toward the first detector to produce the first interferogram, and directing a second portion of the combined light through a fourth polarization filter toward the second detector to produce the second interferogram.

The method may include: transmitting the test light through a first optical component so as to reflect off the test object, and receiving the reflected test light back through the first optical component, in which the first optical component is configured to alter a polarization state of the test light; transmitting the reference light through a second optical component so as to reflect off a reference object, and receiving the reflected reference light back through the second optical component, in which the second optical component is configured to alter a polarization state of the reference light; combining the reflected test light and the reflected reference light into combined light; and directing a first portion of the combined light through a first polarization filter to the first detector to produce the first interferogram, and directing a second portion of the combined light through a second polarization filter to the second detector to produce the second interferogram.

Separating the input beam into the test light and the reference light may include passing the input beam into a polarizing beam-splitter such that the test light and the reference light are orthogonally polarized with respect to one another, in which the method may include: transmitting the test light through a first optical component so as to reflect off the test object, and receiving the reflected test light back through the first optical component, in which the first optical component is configured to alter a polarization state of the test light; transmitting the reference light through a second optical component so as to reflect off a reference object, and receiving the reflected reference light back through the second optical component, in which the second optical component is configured to alter a polarization state of the reference light; combining the reflected test light and the reflected reference light into combined light; transmitting the combined light through a third optical component, in which the third optical component is configured to alter a polarization state of the combined light; and directing a first portion of the combined light through a first polarization filter to the first detector to produce the first interferogram, and directing a second portion of the combined light through a second polarization filter to the second detector to produce the second interferogram.

Separating the input beam into the test light and the reference light may include passing the input beam into a polarizing beam-splitter such that the test light and the reference light are orthogonally polarized with respect to one another, in which the method may further include: transmitting the test light through a first optical component so as to reflect off the test object, and receiving the reflected test light back through the first optical component, in which the first optical component is configured to alter a polarization state of the test light; transmitting the reference light through a second optical component so as to reflect off a reference object, and receiving the reflected reference light back through the second optical component, in which the second optical component is configured to alter a polarization state of the reference light; combining the reflected test light and the reflected reference light into combined light; and directing a first portion of the combined light through a first polarization filter to the first detector to produce the first interferogram, and directing a second portion of the combined light through a second polarization filter and through a third optical component to the second detector to produce the second interferogram, in which the third optical component is configured to alter a polarization state of the second portion.

Separating the input beam into the test light and the reference light may include passing the input beam into a polarizing beam-splitter such that the test light and the reference light are orthogonally polarized with respect to one another, in which the method may include: directing the test light toward the test object and directing the reference light towards the reference object, in which the test light reflects off the test object, and the reference light reflects off the reference object; combining the reflected test light and the reflected reference light in the polarizing beam-splitter to provide combined light; passing the combined light through an optical component configured to alter polarization state of the combined light; directing a first portion of the combined light through a first polarization filter to the first detector to provide the first interferogram; and directing a second portion of the combined light through a second polarization filter to the second detector to provide the second interferogram.

In general, in another aspect, the subject matter of the disclosure may be embodied in a low-coherence scanning interferometry method that includes: for each optical path length difference (OPD) of a sequence of OPDs between test light reflected from a test object and reference light in a scanning interferometer, simultaneously measuring two phase-shifted interferograms corresponding to intensity patterns produced by interfering the test light reflected from a test object with the reference light on respective first and second detectors, in which the test light and reference light are derived from a common source and in which the sequence of OPDs spans a range larger than the coherence length of the common source, the interferograms measured by the first detector defining a first set of scanning interferometry signals corresponding to multiple transverse locations on the test object, the interferograms measured by the second detector defining a second set of interferometry signals corresponding to the substantially the same multiple transverse locations on the test object, in which each interferometry signal in the second set is phase-shifted relative to a corresponding interferometry signal in the first set, in which every interferometry signal comprises a series of intensity values corresponding to the sequence of OPDs; and for each interferometry signal in the second set and the corresponding interferometry signal in the first set, using an electronic processor to apply a global least squares fit to the pair of interferometry signals to determine information about the test object with reduced sensitivity to errors.

Implementations of the method may include one or more of the following features and/or features of other aspects. For example, in some implementations, the information about the test object is any of a relative height map, film thickness map, or surface profile.

In some implementations, the phase shift between each simultaneously measured interferogram is approximately 90°.

In some implementations, the phase shift between each simultaneously measured interferogram is approximately 180°.

In some implementations, the method includes translating a measurement scan position of the test object or a reference object relative to one another to obtain the sequence of OPDs, each intensity value of every interferometer signal being measured at a different measurement scan position. The different measurement scan positions may be separated by uniform scan intervals. The different measurement scan positions may be separated by non-uniform scan intervals. Successive intensity values in each of the interferometry signals may be measured at measurement scan positions alternately separated by a first scan interval and a second scan interval, the first scan interval being less than the scan second interval. The multiple intensity values for each interferometry signal of the first set of scanning interferometry signals may be measured over multiple camera frames of the first detector, in which the multiple intensity values for each interferometry signal of the second set of scanning interferometry signals are measured over multiple camera frames of the second detector. The method may include modulating the test light and reference light. Modulating the test light and reference light may include periodically switching the common source from a substantially off-state to an on-state, and simultaneously measuring two phase-shifted interferograms occurring during the on-state of the common source. The first detector may include a first camera shutter and the second detector may include a second camera shutter, in which modulating the test light and reference light includes periodically opening and closing the first camera shutter and the second camera shutter at approximately the same times, and in which simultaneously measuring two phase-shifted interferograms occurs during the opening of the first camera shutter and the second camera shutter. A camera frame-time for each detector may be greater than a length of time over which each intensity value is measured.

In some implementations, the multiple intensity values for each interferometry signal are acquired at a rate that is less than a Nyquist rate of the interferometry signal.

In some implementations, the only interferometry signals processed by the electronic processor are those from the interferograms measured by the first and second detectors. Applying the global least squares fit for each pair of interferometry signals may include: fitting a first model function to the interferometry signal in the second set; fitting a second model function to the corresponding interferometry signal in the second set; combining the square of the difference between the first model function and the interferometry signal for a series of evaluation scan positions and the square of the difference between the second model function and the corresponding interferometry signal for the series of evaluation scan positions; and determining the evaluation scan position that results in a minimum value for the combination. The first model function and the second model function may be each expressible as including multiple intensity values for corresponding virtual scan positions, the virtual scan positions being defined relative to the measurement scan positions. The one or more parameter values may include a phase value, an average magnitude value, and an offset value.

In some implementations, providing the light beam includes: providing an input beam from the common source; separating, in a polarizing beam-splitter, the input beam into the test light and the reference light such that the test light and the reference light are orthogonally polarized with respect to one another, directing the test light toward the test object and directing the reference light towards the reference object, in which the test light reflects off the test object, and the reference light reflects off the reference object; combining the reflected test light and the reflected reference light in the polarizing beam-splitter to provide combined light; passing the combined light through an optical component configured to alter polarization state of the combined light; directing a first portion of the combined light through a first polarization filter to the first detector to provide the first interferogram; and directing a second portion of the combined light through a second polarization filter to the second detector to provide the second interferogram

In general, in another aspect, the subject matter of the disclosure may be embodied in a low-coherence scanning interferometry system that includes: an interferometry apparatus comprising a light source, an interferometer, a first detector, and a second detector, the apparatus configured to simultaneously measure, for each optical path length difference (OPD) of a sequence of OPDs between test light reflected from a test object and reference light, first and second phase-shifted interferograms corresponding to intensity patterns produced by interfering the test light reflected from a test object with the reference light on the first and second detectors, respectively, the test light and reference light being derived from the light source, each interferogram measured by the first detector defining a first set of scanning interferometry signals corresponding to multiple transverse locations on the test object, each interferogram measured by the second detector defining a second set of interferometry signals corresponding to the substantially the same multiple transverse locations on the test object, in which each interferometry signal in the second set if phase-shifted relative to a corresponding interferometry signal in the first set, every interferometry signal including a series of intensity values corresponding to the sequence of OPDs; and an electronic processor coupled to the interferometry apparatus, in which the electronic processor is configured to perform operations including, i) processing the first set of interferometry signals, independently from the second set of interferometry signals, to obtain first processed information about the test object over the multiple transverse locations, ii) processing the second set of interferometry signals, independently from the first set of interferometry signals, to obtain second processed information about the test object over the multiple transverse locations, and iii) combining the first processed information with the second processed information to determine the information about the test object with the reduced sensitivity to errors.

Implementations of the system may include one or more of the following features and/or features of other aspects. For example, in some implementations, the light source is configured to provide an input light beam, and the system further includes an objective assembly configured to convert the input light beam into the test beam and the reference beam, in which the test beam and the reference beam have orthogonal polarizations states with respect to one another. The objective assembly may be further configured to introduce a phase-shift between constituent components of the test beam and of the reference beam. The input beam may have a linearly polarization state or is unpolarized. Each pixel of the first detector may be aligned to substantially the same location on the test object as a corresponding pixel of the second detector.

In general, in another aspect, the subject matter of the disclosure may be embodied in a low-coherence scanning interferometry system that includes: an interferometry apparatus comprising a light source, an interferometer, a first detector, and a second detector, the apparatus configured to simultaneously measure, for each optical path length difference (OPD) of a sequence of OPDs between test light reflected from a test object and reference light, first and second phase-shifted interferograms corresponding to intensity patterns produced by interfering the test light reflected from a test object with the reference light on the first and second detectors, respectively, the test light and reference light being derived from the light source, each interferogram measured by the first detector defining a first set of scanning interferometry signals corresponding to multiple transverse locations on the test object, each interferogram measured by the second detector defining a second set of interferometry signals corresponding to substantially the same multiple transverse locations on the test object, in which each interferometry signal in the second set if phase-shifted relative to a corresponding interferometry signal in the first set, every interferometry signal comprising a series of intensity values corresponding to the sequence of OPDs; and an electronic processor coupled to the interferometry apparatus, in which the electronic processor is configured to perform operations comprising processing the interferometry signals to determine information about the test object with reduced sensitivity to errors, in which the only interferometry signals the electronic processor is configured to process are those from the interferograms measured by the first and second detectors.

Implementations of the system may include one or more of the following features and/or features of other aspects. For example, in some implementations, the light source is configured to provide an input light beam, and the system further includes an objective assembly configured to convert the input light beam into the test beam and the reference beam, in which the test beam and the reference beam have orthogonal polarizations states with respect to one another. The objective assembly is further configured to introduce a phase-shift between constituent components of the test beam and of the reference beam.

In some implementations, the input beam has a linearly polarization state or is unpolarized.

In some implementations, each pixel of the first detector is aligned to substantially the same location on the test object as a corresponding pixel of the second detector.

The details of one or more embodiments are set forth in the accompanying drawings and the description below. Other features will be apparent from the description, drawings, and claims.

### DESCRIPTION OF DRAWINGS

FIG. 1 is a schematic diagram of an example of a scanning interferometry system.

FIG. 2 is a plot of a simulated interference signal obtained from a detector pixel of a low coherence scanning interferometry system.

FIGS. 3-7 are schematics of different scanning interferometer measurement systems.

FIG. 8 is a schematic that illustrates the concept of punctuated data acquisition.

FIG. 9 is a plot of scan position versus sample number.

FIG. 10 is a plot illustrating a conceptual image of how least squares (LSQ) fitting may be used to fit a model function to an experimental interference signal.

FIG. 11 is a plot of an example coherence scanning interferometry (CSI) signal recorded by a coherence scanning interferometer.

FIG. 12 is a plot of a LSQ merit function for the CSI signal of FIG. 11.

FIG. 13 is a plot of a LSQ merit function for the CSI signal of FIG. 11.

FIG. 14 is a dual plot that illustrates an example of a simulated low coherence interference signal sampled using uniform data sampling.

FIG. 15 is a dual plot that illustrates an example of a simulated low coherence interference signal sampled using a non-uniform data sampling procedure.

FIG. 16a is a schematic diagram of a structure suitable for use in solder bump processing.

FIG. 16b is a schematic diagram of the structure in FIG. 16a after solder bump processing has occurred.

FIG. 17 is a schematic diagram showing a side view of an object which includes a substrate and an overlying layer.

FIG. 18 is a plot illustrating the simulated effect of sparse sampling on height noise for a single detector.

FIG. 19 is a plot illustrating the simulated effect of sparse sampling on height noise for a dual-detector system, in which the height information from the two phase-shifted detectors is averaged.

FIG. 20 is a plot illustrating simulated root mean square (rms) height measurement error versus sinusoid frequency for a single detector at a sub-Nyquist sampling multiplier of 7×.

FIG. 21 is a plot illustrating simulated rms height measurement error versus sinusoid frequency based on averaging height measurement error from two phase-shifted detectors and a sub-Nyquist sampling multiplier of 7×.

FIG. 22 is a plot illustrating simulated rms height measurement error versus sinusoid frequency based on quadrature LSQ fitting of two phase-shifted detectors and a sub-Nyquist sampling multiplier of 7×.

FIGS. 23 and 24 are plots of rms noise as a function of the sub-Nyquist multiplier for a single-camera system and a dual camera system, respectively, where merit function centroiding is used to locate the signal peaks.

FIG. 25 is a plot of simulated deviations in height of a measurement object as a function of height for a single detector at a sub-Nyquist sampling multiplier of 11× and a 5% ramp rate miscalibration.

FIG. 26 is a plot of simulated deviations in height of a measurement object as a function of height based on averaging height deviation from two-phase shifted detectors, a sub-Nyquist sampling multiplier of 11×, and a 5% ramp rate miscalibration.

FIG. 27 is a plot of simulated deviations in height of a measurement object as a function of height for a single detector at a sub-Nyquist sampling multiplier of 11×, 10 nm rms noise, and a 5% ramp rate miscalibration.

FIG. 28 is a plot of simulated deviations in height of a measurement object as a function of height based on averaging height deviation from two-phase shifted detectors, a sub-Nyquist sampling multiplier of 11×, 10 nm rms noise, a 5% ramp rate miscalibration, and a 5° quadrature calibration error.

### DETAILED DESCRIPTION

Embodiments of coherence scanning interferometry and systems for performing the same are disclosed in which two detectors imaging the same surface simultaneously acquire interference information, where there is a relative phase shift between the information acquired by the first detector and the information acquired by the second detector. The information acquired by the two detectors is obtained over a scan range that is greater than a coherence length of the source light used for the scanning interferometry. An electronic processor coupled to the two detectors processes the interferometry signals from the two detectors to determine topography information about the surface being imaged. The electronic processor may be configured to process the interferometry signals from the first detector independently from the interferometry signals from the second detector, and then combine the independently processed signals to produce the topography information. Alternatively, or in addition, the electronic processor may be configured to process the interferometry signals from the two detectors together to produce the topography information, in which the interferometry signals from the two detectors are the only interferometry signals processed by the electronic processor. One or more embodiments of the coherence scanning interferometry technique may be useful for obtaining topography information about a surface while minimizing signal noise due to vibration errors and/or scan-related errors, and for enhancing data acquisition rates.

The following disclosure is divided into separate sections. First, examples of a scanning interferometer system for simultaneously acquiring phase-shifted interference signals at two detectors are described. Then, methods for acquiring interferometry signals in quadrature for vibration compensation and speed enhancement are discussed. The principles of sliding window least squares (LSQ) analysis utilizing discrete sampling of the phase-shifted interferometry signals obtained from the two detectors are then presented. Finally, exemplary applications for the coherence scanning methods are presented and examples of pattern matching to simulated phase-shifted interference signals for different acquisition techniques are described.

### Low Coherence Scanning Interferometers for Simultaneous Measurement of Phase-Shifted Interferometry Signals

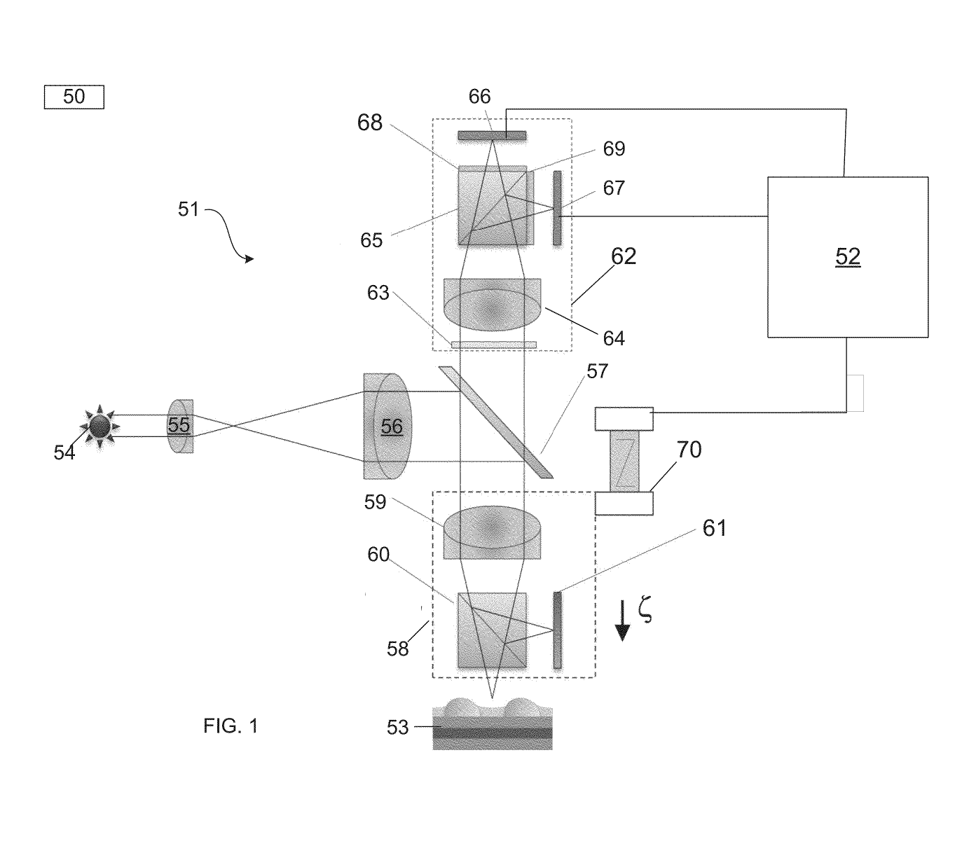

Referring to FIG. 1, an exemplary measurement system 50 for obtaining interference signals includes an interferometer 51 electronically coupled to a computer control system 52. The measurement system 50 is operable to determine one or more spatial properties of a measurement object 53. In some implementations, the one or more spatial properties relate to a topography of measurement object 53, such as a thickness of a thin film or surface height. The spatial properties may be determined in the form of a profile map over a defined area of the measurement object 53. Alternatively, or in addition, the spatial properties relate a location of the object 53 with respect to another object, e.g., a portion of system 50. In some implementations, the other object is a reference portion of a solder bump metrology system. In any event, system 50 is operable to determine one or more spatial properties of objects including one or more at least partially covering layers, e.g., a substrate contacted with a layer of photoresist or solder (e.g., a solder bump).

Source 54 may be a spectrally-broadband source, such as a white-light lamp, or may include a plurality of different wavelengths, e.g., resulting from a plurality of light emitting diodes. As an alternative or in combination with a broadband source, the source 54 can include a narrow band or quasi-monochromatic source. The light emitted from source 54 can be polarized or unpolarized (i.e., randomly polarized).

First lens component 55, which may include, for example, an achromatic doublet, expands and transmits a beam emitted from source 54. A second lens component 56, which may also include an achromatic doublet, transmits a collimated beam to a beam-splitting element 57 that reflects the incident beam toward a polarized objective 58. The polarized objective 58 includes components arranged to separate the incident beam into a separate test beam and a reference beam having different polarizations. For example, polarized objective 58 may be a polarized Michelson objective that includes a third lens component 59 and a polarizing beam-splitter 60. Third lens component 59 may include, for example, an achromatic doublet or other objective lens to direct input light towards (and collect light from) the test and reference surfaces. Preferably, third lens component 59 has a numerical aperture suitable for resolving features on the surface of measurement object, while also allowing one to image a relatively large field of view. As an example, third lens component 59 may have a numerical aperture of about 0.2. Third lens component 59 transmits the incident beam from beam-splitting element 57 toward polarizing beam-splitter 60, which then separates the incident beam into a polarized test beam and a polarized reference beam. For example, polarizing beam-splitter 60 may transmit only portions of the incident beam having a first polarization, while reflecting only portions of the incident beam having a second polarization that is orthogonal to the first polarization, such that a linearly polarized test beam and a linearly polarized reference beam are formed. In the Michelson-type objective, the beam-splitting interface of beam-splitter 60 is oriented at an acute angle to the optical axis defined by third lens component 59 (e.g., at 45 degrees) to direct the reference beam to a side reference object 61 and to direct the test beam on measurement object 53.

In some implementations, reference object 61 is optically flat and includes only a single reflecting surface. For example, reference object 61 may be a reference mirror. In some implementations, reference object 61 exhibits a three-dimensional surface topography and/or includes more than one spaced-apart layer that reflects light. In the following discussion, it is assumed without limitation that reference object 61 is a reference mirror including a single reflective surface.

Polarizing beam-splitter 60 combines light reflected from reference mirror 61 and from measurement object 53. The combined light is directed back to third lens component 59, which collimates and transmits the combined light toward beam-splitting element 57. At least a portion of the combined light passes through beam-splitting element 57 and is incident on a detector assembly 62.

As explained above, the reference and test beam paths are encoded by polarization using beam-splitter 60. The polarization encoding allows controlled phase shifts to be introduced using both polarizers and waveplates elsewhere in interferometer 51. For example, detector assembly 62 includes a waveplate 63, a fourth optical component 64, a beam-splitting element 65, a first detector 66, a second detector 67, a first polarizer 68, and a second polarizer 69. The combined light first passes through waveplate 63, which shifts the phase between the polarized reference and test beam components of the combined light. For example, waveplate 63 may be a quarter-wave plate with its optical axis oriented at 45° with respect to the orthogonally polarized components of the combined beam. This waveplate converts the linearly polarized measurement and reference beams into circularly polarized light beams, where there is an approximately 90° phase shift between the constituent components of the reference and test beams (e.g., the constituent electric-field components E_{y} and Eₓ). Other phase shifts may be introduced as well. As noted further below, different optical elements within detector assembly 62 can produce different phase shifts so as to allow light to reach each detector.

The combined light having the reference and test beam components with their relative phase shifts is then transmitted by fourth optical component 64 to beam-splitting element 65. Fourth optical component 64 is an imaging lens and may be another achromatic doublet or other optical component arranged to focus the incoming beam. Beam-splitting element 65 is a non-polarizing beam-splitter that directs a first portion of the combined light toward first detector 66 and a second portion of the combined light toward second detector 67. Prior to reaching the detectors, however, each portion of the combined light derived by beam-splitting element 65 passes through a corresponding polarizer element. For example, the first portion of combined light passes through first polarizer 68 with its optical axis oriented at a first angle (e.g., 0°), and the second portion of the combined light passes through second polarizer 69 with its optical axis oriented at a second different angle (e.g., 45°). Each polarizer element blocks the components of light that are not aligned with the polarizer element's optical axis. Given that the reference and test beams are circularly polarized from waveplate 63, the first beam portion and second beam portion will each include part of the test beam component and reference beam component. However, the first beam portion and second beam portion will be phase-shifted relative to one another. The polarizer elements may be formed as thin films on faces of beam-splitting element 65 using fabrication techniques known in the art. Alternatively, the polarizer elements may be separate stand-alone components.

The first portion of the combined beam passing through first polarizer 68 is focused onto first detector 66. Similarly, the second portion of the combined light passing through second polarizer 69 is focused onto second detector 67. Since each portion of combined light includes a reflected test beam component and a reflected reference beam component, the two components interfere at each detector to produce a corresponding detector signal indicative of the resultant beam intensity.

Each detector typically includes a plurality of detector elements, e.g., pixels, arranged in at least one and more generally two dimensions. In the following discussion, it is assumed without limitation that each of first detector 66 and second detector 67 includes a two-dimensional array of detector elements. For example, the detectors may each be a CCD that includes multiple pixels. In the embodiment shown in FIG. 1, the first portion of the combined light is focused by fourth lens component 64 (after passing through beam-splitter 65) onto first detector 66 so that each detector element of detector 66 corresponds to a respective point, e.g., a small region or location of measurement object 53. Similarly, (after being reflected by beam-splitter 65) the second portion of the combined light is focused by fourth lens component 64 onto second detector 67 so that each detector element of second detector 67 corresponds to a respective point of measurement object 53. Thus, an interference pattern can be observed at each of the first and second detector, even for extended (i.e. spatially incoherent) illumination. The interference pattern recorded across the array of pixels of each detector is referred to as an interferogram.

In the present embodiment, first detector 66 and second detector 67 are aligned such that the image points for each of the two detectors correspond to substantially the same points on the measurement object 53. For example, assume the pixels of first detector 66 are arranged in a two-dimensional array in the x and y directions, such that each pixel P₁ of first detector 66 is located at a different coordinate, P₁(x, y). Similarly, assume the pixels of second detector 67 are arranged in a two-dimensional array in the y and z directions, such that each pixel P₂ of second detector is locate at a different coordinate, P₂(y, z). The two detectors are then aligned so that the same image point Pₘ on the measurement object is imaged by a pair of pixels, i.e., P₁(x, y) from first detector 66 and P₂(y, z) from second detector 67. That is, each pixel of first detector 66 is aligned to record test beam and reference beam interference resulting from the substantially same image point as a corresponding pixel of second detector 67. Ideally, each pixel is aligned to exactly the same image point; however, a certain amount of misalignment is acceptable so long as the effect on the measurable spatial frequencies of the object under test is sufficiently small. For example, given that the measurable spatial frequency content is generally limited by system optical resolution and spatial sampling, an acceptable level of misalignment between pixels may be about 1/10th of a pixel. As explained above, the first portion of the combined beam and the second portion of the combined beam have a relative phase shift between them. Therefore, even though the pixels of the detectors are aligned to image the same points on measurement object 53, the interferograms recorded by first detector 66 and second detector 67, if recorded at substantially the same time, will be phase-shifted relative to one another. The phase-shift between the simultaneously acquired interferograms can be, for example, about 90°, about 180°, or any other phase-shift.

System 50 is typically configured to create an optical path length difference (OPD) between light directed to and reflected from reference object 61 and light directed to and reflected from measurement object 53. In some implementations, measurement object 53 can be displaced or actuated by an electromechanical transducer, such as a piezoelectric transducer (PZT), and associated drive electronics 70 controlled by computer control system 52 so as to effect precise scans along a direction that varies the OPD of the interferometer 51. In some implementations, system 50 is configured to modify the OPD by moving reference object 61; in other implementations, system 50 is configured to modify the OPD by moving measurement object 53. For example, as shown in FIG. 1, polarized objective 58, which includes reference object 61, may be coupled to a transducer 71 that adjusts a position of objective 58 along the z-direction. In some implementations, system 50 is configured to modify the OPD by an amount at least as great as height variations in a topography of measurement object 53. For example, in the case of solder-bump metrology, the OPD may be varied by about 60 microns or greater. In some implementations, the OPD is varied by a distance at least as great as a coherence length of the interferometer, e.g., on the order of a few microns.

As the OPD is modified, such by scanning a position of measurement object 53 or a position of reference object 61, first detector 66 and second detector 67 simultaneously record a plurality of detector signals. For the purposes of this disclosure, simultaneous recording of detector signals means that, for a particular OPD, the exposure/integration time of first detector 66 and second detector 67 occur at the same time. The detector signals thus acquired can be stored in digital format as an array of interference signals, where each pixel acquires a corresponding interference signal, and each interference signal represents a variation in intensity as a function of OPD for a different location of measurement object 53 or reference object 61, depending on which object is translated. For example, if first detector 66 and second detector 67 each include a 128×128 array of pixels, and if 64 images are stored by each detector during a scan, then there will be approximately 32,000 interference signals (approximately 16,000 for each detector), each of which is 64 data points in length, recorded altogether by the two detectors. Furthermore, just as the interferograms recorded on first detector 66 and second detector 67 are phase shifted relative to one another for a particular OPD, each interference signal recorded by a pixel of first detector 66 for a range of OPD is phase-shifted relative to an interference signal recorded by a corresponding pixel of second detector 67 for the same range of OPD, if the pixels are aligned to image approximately the same point on measurement object 53. In embodiments using a broadband source 54, the interference signals may be referred to as scanning white light interferometry (SWLI) interference signals, more generally as low coherence length scanning interference signals.

After the data has been acquired, the computer 52 can process the interference signals from each detector to determine information about measurement object 53. For example, in some implementations, computer 52 can process the interference signals from first detector 66 independently from the interference signals from second detector 67 in accordance with, e.g., pattern fitting techniques. The information obtained by processing the interference signals from both the first and second detectors may be independent of the OPD. For example, electronic processor may independently obtain from each of the first detector 66 and the second detector 67 a corresponding map of data values that are representative of information about measurement object 53. Each map may include multiple data values, in which each data value of a particular map corresponds to a different transverse location (e.g., in the x- or y-direction) on measurement object. Because of the alignment of the first and second detectors, the data values in the map obtained from the first detector 66 correspond to the same transverse locations as the data values in the map obtained from the second detector 67. The data values may be representative of information such as a height of measurement object 53, a thickness of a film or films on measurement object, or a refractive index. The data values may be representative of other information about measurement object 53 as well.

Computer 52 then may combine the independently processed information to produce data about the measurement object 53. For example, the data from the combined information may be indicative of a surface topography of the measurement object. Alternatively, or in addition, the data may be indicative of a thickness profile for a film formed on measurement object. In some implementations, computer 52 processes the information from both detectors together to produce data about the measurement object 53. For example, computer 52 may apply a global fit to the information obtained from first detector 66 and second detector 67.

The embodiment shown in FIG. 1 schematically shows an interferometer of the Michelson type, in which beam splitter 60 directs reference light away from an optical axis of the test light (e.g., the beam splitter can be oriented at 45 degrees to the input light so the test light and reference travel at right angles to one another). In other embodiments, interferometry system 50 can include other types of interferometers. For example, the interferometry system may include a microscope configured for use with one or more different interference objectives, each providing a different magnification. Each interference objective includes a beam splitter for separating input light into test light and reference light.

Examples of different interference objectives include a Mirau-type interference objective. In the Mirau-type object, the beam-splitter is oriented to direct the reference light back along the optical axis to a small reference mirror in the path of the input light. The reference mirror can be small, and thereby not substantially affect the input light, because of the focusing by the objective lens). In a further embodiment, the interference objective can be of the Linnik-type, in which case the beam splitter is positioned prior to the objective lens for the test surface (with respect to the input light) and directs the test and reference light along different paths. A separate objective lens is used to focus the reference light to the reference lens. In other words, the beam splitter separates the input light into the test and reference light, and separate objective lenses then focus the test and reference light to respective test and reference surfaces. Ideally the two objective lenses are matched to one another so that the test and reference light have similar aberrations and optical paths. In some implementations, the system can be configured to collect test light that is transmitted through, rather than reflected by, the test sample and then subsequently combined with reference light. For such embodiments, for example, the system can implement a Mach-Zehnder interferometer with dual microscope objectives on each leg.

Light source 54 in the interferometer may be any of: an incandescent source, such as a halogen bulb or metal halide lamp, with or without spectral bandpass filters; a broadband laser diode; a light-emitting diode; a combination of several light sources of the same or different types; an arc lamp; any source in the visible spectral region (between about 390 nm and about 700 nm); any source in the near-infrared (IR) spectral region (between about 700 nm and 3 microns); and any source in the UV spectral region (between about 390 nm and about 10 nm). For broadband applications, the source preferably has a net spectral bandwidth broader than 5% of the mean wavelength, or more preferably greater than 10%, 20%, 30%, or even 50% of the mean wavelength. For tunable, narrow-band applications, the tuning range is preferably broad (e.g., greater than 50 nm, greater than 100 nm, or greater than even 200 nm, for visible light) to provide reflectivity information over a wide range of wavelengths, whereas the spectral width at any particular setting is preferable narrow, to optimize resolution, for example, as small as 10 nm, 2 nm, or 1 nm. Source 54 may also include one or more diffuser elements to increase the spatial extent of the input light being emitted from the source.

In some implementations, light source 54 may include the ability to modulate its output intensity. For example, light source 54 may be coupled to computer 52 or another controller that can modulate the intensity of light output by source 54. The source 54 may be modulated between being substantially off (e.g., no light or almost no light emitted by source 54, such that a detector measures zero intensity) to being substantially on (e.g., the source 54 emits light at full intensity or an intensity sufficient to be measured by a detector). In some implementations, the source 54 may be configured to provide polarized or non-polarized light. For example, the source 54 may include one or more optical elements to alter a polarization of the light emitted by source 54 so as to obtain a desired polarization such as linear or circular polarization.

Though not shown, interferometer 50 may also include one or more apertures such as, for example, an aperture located between first lens component 55 and second lens component 56 and/or between beam-splitting element 57 and detector assembly 62. Apertures can be placed in other suitable locations in interferometer 50, as well.

The electronic detectors can be any type of detector for measuring an optical interference pattern with spatial resolution, such as a multi-pixel CCD or CMOS camera capable of recording multiple frames per second. For example, the detector may have a camera frame rate of about 10 frames/sec, 25 frames/sec, 50 frames/sec, 75 frames/sec, or 100 frames/sec. Other frame rates are possible as well. Each detector may also include a shutter (mechanical or electrical) capable of blocking light incident on the detector's surface when the shutter is closed. Instead of altering light intensity output by source 54, light modulation can be achieved by opening and closing the shutters on the detectors. In some implementations, the detectors include or are electronically coupled to a controller that operates the shutter opening and closing. For example, in some cases, the controller for operating the shutters may be a part of computer 52.

Furthermore, the various translation stages in the system, such as translation stage 70, may be: driven by any of a piezo-electric device, a stepper motor, and a voice coil; implemented opto-mechanically or opto-electronically rather than by pure translation (e.g., by using any of liquid crystals, electro-optic effects, strained fibers, and rotating waveplates) to introduce an optical path length variation; any of a driver with a flexure mount and any driver with a mechanical stage, e.g. roller bearings or air bearings. The translation stages may allow variable scan speeds along the direction of translation of the measurement and/or reference object. For example, the scan speed may be about 0.5 micron/sec, 1 micron/sec, 10 micron/sec, 20 micron/sec, 30 micron/sec, 40 micron/sec, or 50 micron/sec. Other scan speeds are possible as well. The absolute scan range over which the translation stage moves may also vary. For example, the scan range may span a distance of about 5 microns, 10 microns, 20 microns, 25 microns, 30 microns, 40 microns, 50 microns. Other scan ranges are also possible.

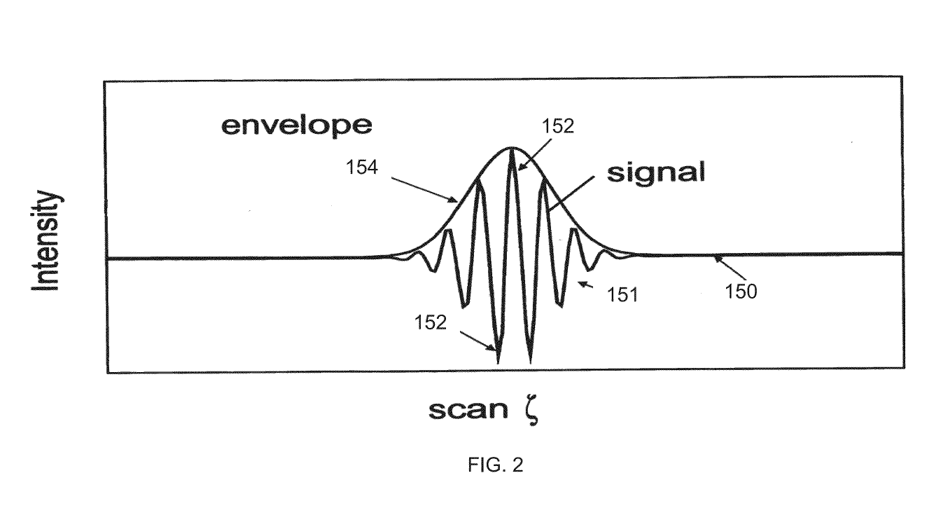

FIG. 2 is a plot of a simulated interference signal 150 obtained from a detector pixel of a low coherence scanning interferometry system, such as system 50. Interference signal 150 includes a plurality of detector intensity values obtained from a single point of an object, e.g., a point of a silicon wafer having a single reflective interface. The intensity values measured by the detector pixel are plotted as a function of OPD between test light reflected from the object point and reference light reflected from a reference object. The collection of intensity values across the array of pixels of a detector for a particular OPD corresponds to an interferogram. Interference signal 150 is a low coherence scanning white light interferometry (SWLI) signal obtained by scanning the OPD, e.g., by moving an optic, the measurement object, and/or the reference object to vary the optical path traveled by the test light or the reference light.

In FIG. 2, the intensity values are plotted as a function of OPD (here scan position ζ) and map out an interference pattern 151 having a plurality of fringes 152, which decay on either side of a maximum according to a low coherence envelope 154. In the absence of a low coherence envelope, the fringes of an interference pattern typically have similar amplitudes over a wide range of optical path differences. The envelope 154 itself does not expressly appear in such interference signals but is shown for discussion. The location of the interference pattern along the OPD axis is generally related to a position of zero OPD, e.g., a scan position corresponding to zero OPD between light reflected from the object point and from a reference object. The zero OPD scan position is a function of the object topography, which describes the relative height of each object point, and the orientation and position of the object itself, which influences the position of each object point with respect to the interferometer. The interference signal also includes instrumental contributions related to, e.g., the interferometer optics, e.g., the numerical aperture (NA) of the optics, the data acquisition rate, the scan speed, the wavelengths of light used to acquire the interference signal, the detector sensitivity as a function of wavelength, and other instrumental properties.

The width of the coherence envelope 154 that modulates the amplitudes of fringes 152 corresponds generally to the coherence length of the detected light. Among the factors that determine the coherence length are temporal coherence phenomena related to, e.g., the spectral bandwidth of the source, and spatial coherence phenomena related to, e.g., the range of angles of incidence of light illuminating the object. Typically, the coherence length decreases as: (a) the spectral bandwidth of the source increases and/or (b) the range of angles of incidence increases. Depending upon the configuration of an interferometer used to acquire the data, one or the other of these coherence phenomena may dominate or they may both contribute substantially to the overall coherence length. The coherence length of an interferometer can be determined by obtaining an interference signal from an object having a single reflecting surface, e.g., not a thin film structure. The coherence length corresponds to the full width half maximum of the envelope modulating the observed interference pattern.

As can be seen from FIG. 2, a coherence scanning interference (CSI) signal 150 results from detecting light having a range of optical path differences that varies by more than the width of the coherence envelope and, therefore, by more than the coherence length of the detected light. In general, a low coherence interference signal can result from obtaining interference fringes that are amplitude modulated by the coherence envelope of the detected light. For example, the interference pattern may be obtained over an OPD for which the amplitude of the observed interference fringes differs by at least 20%, at least 30% or at least 50% relative to one another.

A low coherence interferometer can be configured to detect an interference signal over a range of OPD's that is comparable to or greater than the coherence length of the interferometer. For example, the range of detected OPD's may be at least 2 times greater or at least 3 times greater than the coherence length. In some implementations, the coherence length of the detected light is at least greater than a nominal wavelength of the detected light.

As will be explained in further detail below, different approaches may be used to obtain the intensity values for the interferometry signals. For example, in some embodiments, a pixel acquires the intensity values of an interferometry signal at uniform intervals. That is, each intensity value of an interference signal is acquired over a range of OPD, where the difference between each successive OPD is the same. In some embodiments, the intensity values are acquired by each pixel of a detector at non-uniform intervals. For example, the intensity values of an interferometry signal may be acquired in a “punctuated” manner, such that intensity values are acquired in successive pairs, where the scan distance between intensity values in each pair is short (e.g., within the length of a single fringe) relative to the scan distance between pairs (e.g., over the length of multiple fringes).

In some embodiments, the data acquisition rate at which the intensity values are recorded may be sparse relative to the corresponding interference pattern being sampled. For example, referring to the interference signal 150 shown in FIG. 2, the intensity values may be recorded at scan intervals that are greater than one-quarter of the wavelength of fringes 152. In some implementations, the intensity values may be recorded at scan intervals that result in sub-Nyquist sampling of the underlying interference signal over the range of OPDs being scanned (typically but not limited to, odd integer multiples of ¼ of the fringe period). Advantages of sparse acquisition of data intensity values include a decrease in the time required to perform a scan over a specified distance, since fewer data points are being recorded. Of course, sparse acquisition of intensity values using a single detector may substantially increase noise in the detected interference signal, making recovery of the underlying signal difficult, if not impossible. However, for certain implementations, the use of multiple detectors aligned to the same image point on a measurement object in which the signals measured at each detector are phase-shifted relative to one another allows the signal to be recovered with low noise and improved resistance to errors.

Just as the intervals between scan positions may be non-uniform, the rate at which intensity values are acquired may be non-uniform. In some embodiments, the velocity at which a measurement object or reference object is scanned may be increased in regions between positions at which data intensity values are acquired. For example, the scan velocity may be sped up when translating the measurement object or reference object over regions where no surface is known to exist or where data acquisition is not desired. Accordingly, in some implementations, the time taken for acquiring data over the length of a scan can be reduced.

In some implementations, the measurement object can include more than one reflective surface such as a substrate including one or more at least partially optically transmissive layers. A first reflective surface is defined by the interface between the outermost optically transmissive layer and the surrounding atmosphere (or vacuum). Additional reflective surfaces are defined by each interface between layers or between layers and the substrate. In such embodiments, the light reflected from the measurement object can include a contribution, e.g., a separate beam, reflected from each reflective surface or interface. Because each reflective surface or interface is generally spaced apart along the axis of beam propagation, each separate beam generates a different interference pattern when combined with light reflected from the measurement object. The interference pattern observed by the corresponding detector includes the sum of the interference patterns generated by each separate beam reflected from the measurement object. As the measurement object and/or reference object is scanned through the range of OPDs, and depending on the thickness of the later or layers, the interference signals produced from each interface may overlap.

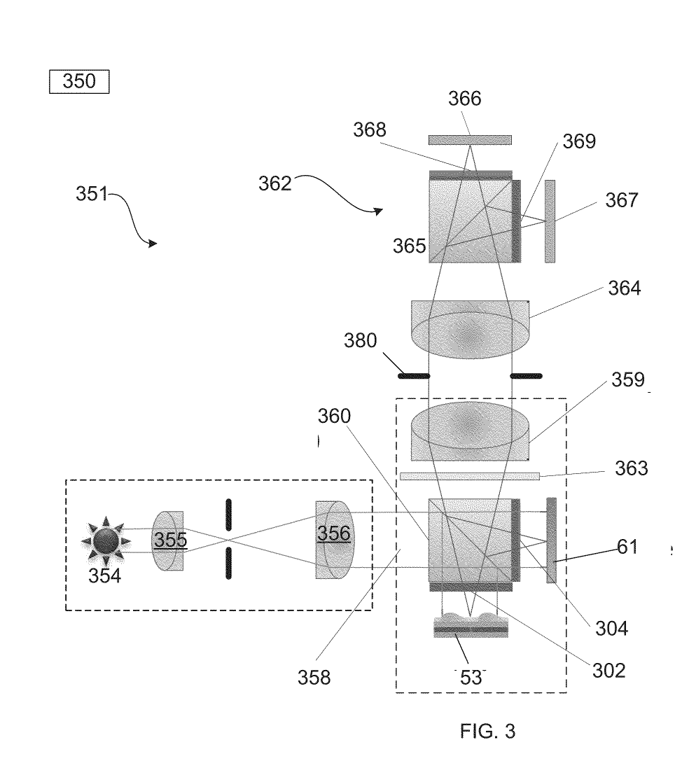

Additional configurations of the interferometer described above are also possible. For example, FIGS. 3-7 are schematics depicting alternative configurations of the low coherence interferometer system shown in FIG. 1. For ease of viewing, the computer control systems are not shown in FIGS. 3-7. Similar to interferometry system 50, each interferometer shown in FIGS. 3-7 includes two separate detectors mutually aligned to the same locations on a measurement object and also arranged to simultaneously measure interference signals as a function of scanned OPD between a test beam and measurement beam. The reference and test beam paths are encoded by polarization at certain points in the interferometers, which allows for controlled phase shifts between interference signals using both polarizers and waveplates. For each OPD, the interference signals measured at the first detector exhibit a relative phase shift with respect to corresponding interference signals measured at the second detector. The computer control systems in each configuration are operable to either process the interference signals recorded at the first detector independently from the interference signals from the second detector to obtain topography information about the measurement object or process the interference signals from each detector together, in which the only interference signals processed by the control system are obtained from the two detectors. Variations of the interferometer configurations shown in FIGS. 1 and 3-7 are also possible.

FIG. 3 is a schematic of an exemplary interferometer measurement system 350 for obtaining topography information about a measurement object, in which the system 350 includes an interferometer 351. Interferometer 351 includes a source 354, first and second lens components 355, 356, an objective assembly 358 and a detector assembly 362. In contrast to the embodiment shown in FIG. 1, source 354 produces light that is linearly polarized at 45°. Furthermore, interferometer 351 includes two, rather than three, beam-splitting elements: first beam splitter 360 in objective assembly 358 and second beam splitter 365 in detector assembly 362, both of which are non-polarizing beam-splitting elements. Beam splitter 360 receives the polarized input beam from source 354 and splits the beam into a test beam and reference beam. The test beam is reflected toward measurement object 53, whereas the reference beam is transmitted by beam splitter 360 toward reference object 61. Prior to reaching measurement object 53, the test beam passes through a first polarizer 302 having its optical axis at 90°. Similarly, reference beam passes through a second polarizer 304 having its optical axis aligned at 0°. Accordingly, orthogonally polarized test and reference beams are formed. After reflecting of measurement object 53 and reference object 61, the test and reference beams pass once more through their respective polarizers and recombine at beam-splitter 360. The recombined beam then passes through wave plate 363. In the present example, wave plate 363 is arranged outside of detector assembly 362 either in front of objective lens 359 or between objective lens 359 and aperture stop 380. Similar to the example shown in FIG. 1, wave plate 363 introduces a phase shift between the different constituent components of the orthogonally polarized beams. The beam then is collimated by objective lens component 359 and passes through aperture 380 and an imaging lens 364 to beam splitter 365. Beam splitter 365 directs a first light beam portion of the combined beam to a first detector 366 and a second light beam portion of the combined beam to a second detector 367. Prior to reaching the detectors, however, each portion of the combined light derived by beam-splitting element 365 passes through a corresponding polarizer element. For example, the first portion of combined light passes through the first polarizer 368 with its optical axis oriented at a first angle (e.g., 0°), and the second portion of the combined light passes through the second polarizer 369 with its optical axis oriented at a second different angle (e.g., 45°). Given that the reference and test beams are circularly polarized from waveplate 363, the first beam portion and second beam portion will each include part of the test beam component and reference beam component. However, the first beam portion and second beam portion also will be phase-shifted relative to one another.

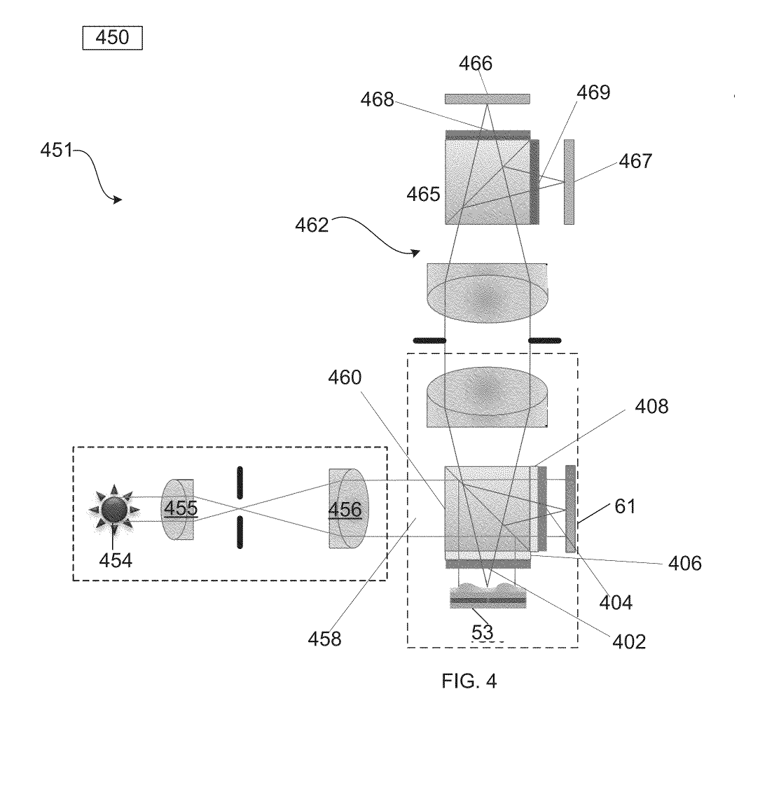

FIG. 4 is a schematic of another exemplary interferometer measurement system 450. Interferometer 451 of system 450 includes a source 454, first and second lens components 455, 456, an objective assembly 458 and a detector assembly 462. Source 454 can produce light having any polarization state. Similar to the configuration shown in FIG. 3, the objective assembly 458 includes a non-polarizing beam-splitting element 460. In contrast to FIG. 3, however, the objective assembly 458 also includes a first wave plate 406 (e.g., a quarter wave plate with its optical axis aligned at 45°) arranged between an output face of the beam-splitting element 460 and first polarizer 402. Objective assembly 458 also includes a second wave plate 408 (e.g., a quarter wave plate with its optical axis aligned at 45°) arranged between an output face of beam-splitting element 460 and second polarizer 404. The waveplates 406, 408 may be thin films fabricated on the outer faces of beam splitter 460 according to know fabrication techniques. Wave plates 406 and 408 accomplish the same function as the waveplates in FIGS. 1 and 3, which is to apply a phase shift to the constituent components of the test and reference beams. However, in this example, the phase shifts are applied prior to combining the reflected test and measurement beams. Accordingly, no waveplate is needed as part of the objective assembly 458 or between the objective assembly 458 and the detector assembly 462. The detection of the phase-shifted signals in interferometer 451 is similar to that shown in FIGS. 1 and 3. That is, the beam splitter 465 of detector assembly 462 separates the combined beam into first and second beam portions, each of which passes through a corresponding polarizer (468, 469) before reaching the first detector 466 and second detector 467, respectively, of the detector assembly 462. As in previous examples, the measurement and reference beams interfere at each detector, in which there is a relative phase shift between the interference signals recorded at the two detectors.

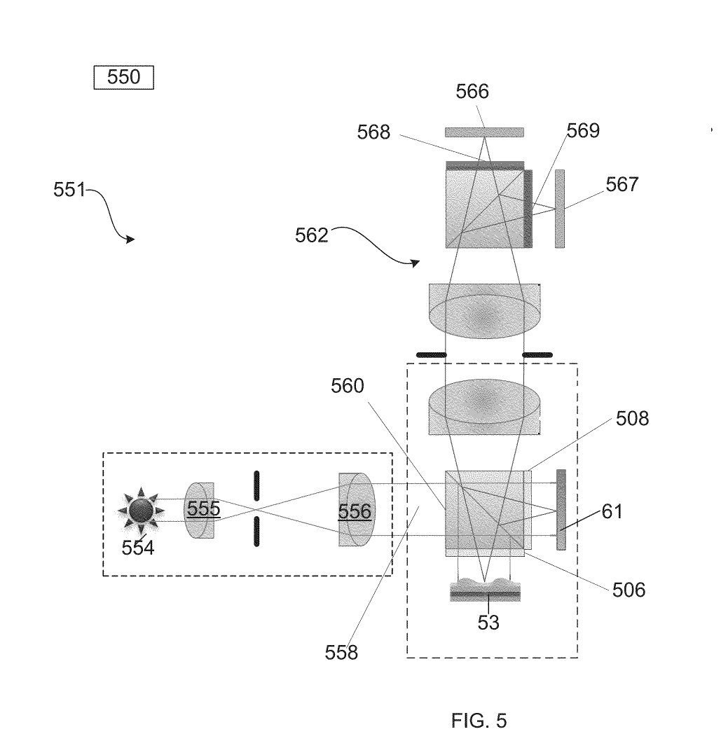

FIG. 5 is a schematic of another exemplary interferometer measurement system 550. Interferometer 551 of system 550 includes a source 554, first and second lens components 555, 556, an objective assembly 558 and a detector assembly 562. The source 554 in this example provides either vertical or horizontally polarized incident light. Similar to the configuration shown in FIG. 4, the objective assembly 558 includes a non-polarizing beam splitter 560 and two separate waveplates: a first wave plate 506 in the test beam path and a second wave plate 508 in the reference beam path. In the present example, however, the first wave plate 506 is a ⅛ waveplate having its optical axis oriented at −45° and the second wave plate 508 is a ⅛ waveplate having its optical axis oriented at +45°. Each of the test beam and reference beam makes two passes through the corresponding ⅛ wave plate in its beam path. The cumulative effect of passing through the wave plates twice is similar to each of the test and reference beam passing through a quarter wave plate. Similar to previous examples, the combined beam then is split in the detector assembly 562 so that a first portion passes through a polarizer 568 to first detector 566 and a second portion passes through a second polarizer 569 to a second detector 567, such that the two portions have a relative phase-shift between them upon reaching their respective detectors. The configuration shown in FIG. 5 is especially suited for reduced sensitivity to birefringent effects of the measurement object 53.

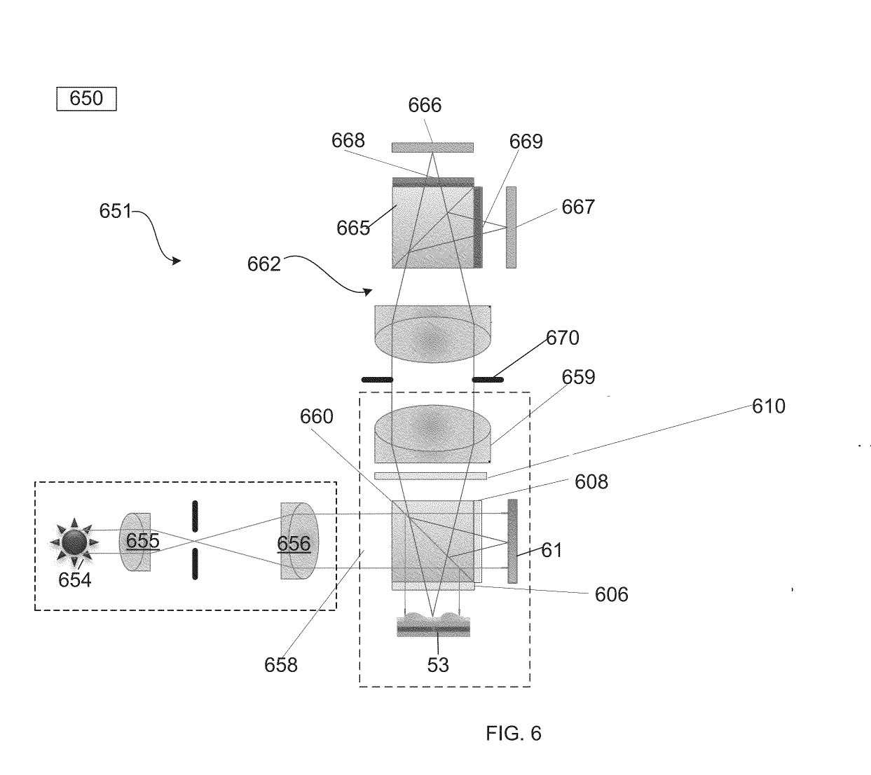

FIG. 6 is a schematic of another exemplary interferometer measurement system 650. Interferometer 651 of system 650 includes a source 654, first and second lens components 655, 656, an objective assembly 658 and a detector assembly 662. Source 654 produces illumination that is linearly polarized at 45°. The beam-splitter 660 of objective assembly 658 in this example is a polarizing beam-splitter that separates the linearly polarized light into orthogonally polarized test and reference beam components. The first wave plate 606 and the second wave plate 608 of objective assembly 658 are each quarter wave plates having their optical axes arranged at +45°. When the reference beam and test beam pass through the wave plates, they are each converted to circularly polarized light before reaching the reference object and test object. The reference beam and test beam are then reflected by the reference object 61 and measurement object 53, respectively, at which point they pass a second time through the waveplates formed on the beam splitter 660 and are converted back to linearly polarized light. The test and reference beams are combined by beam splitter 660 and directed to a third waveplate 610 (e.g., a quarter wave plate having its optical axis arranged at)+45° prior to being directed to the detector assembly 662. Alternatively, third waveplate 610 may be placed downstream of an objective lens 659 and upstream of a stop 670 instead of being placed upstream of objective lens 659. The third wave plate 610 adds a phase shift to the constituent components of the test and reference beams. Similar to the configuration shown in FIG. 1, the combined beam is directed to the detector assembly 662. Beam splitter 665 in detector assembly 662 directs a first light beam portion of the combined beam to a first detector 666 and a second light beam portion of the combined beam to a second detector 667. Prior to reaching the detectors, however, each portion of the combined light derived by beam-splitting element 665 passes through a corresponding polarizer element. For example, the first portion of combined light passes through the first polarizer 668 with its optical axis oriented at a first angle (e.g., 0°), and the second portion of the combined light passes through the second polarizer 669 with its optical axis oriented at a second different angle (e.g., 45°). The first beam portion and second beam portion are phase-shifted relative to one another, and each portion contains a contribution from the reference beam and the test beam.

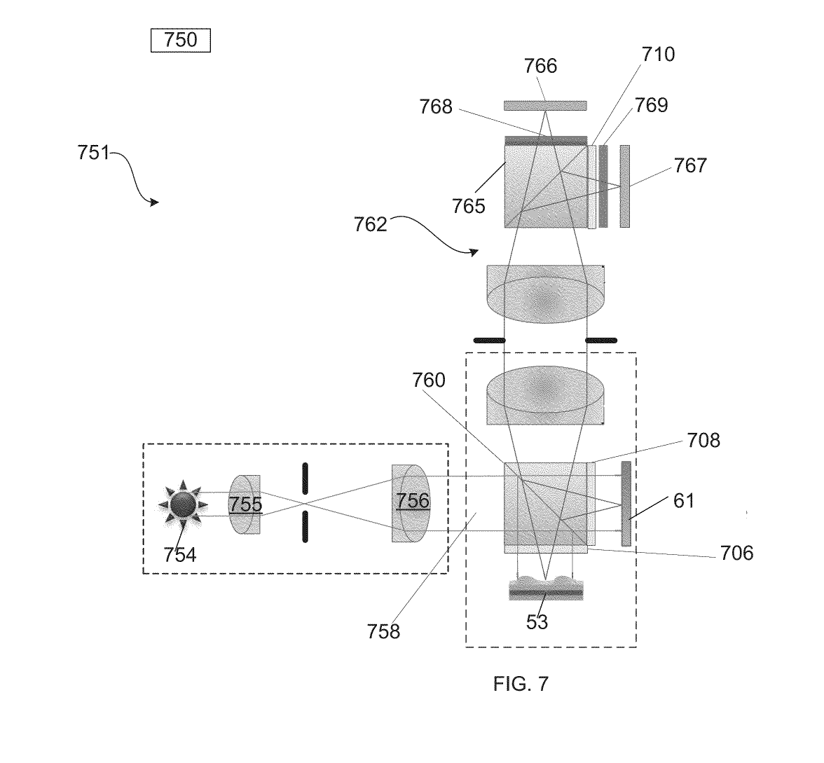

FIG. 7 is a schematic of another exemplary interferometer measurement system 750. Interferometer 751 of system 750 includes a source 754, first and second lens components 755, 756, an objective assembly 758 and a detector assembly 762. Similar to the configuration shown in FIG. 6, the objective assembly includes a polarizing beam-splitting element 760 and two wave plates: a first wave plate 706 arranged between the beam-splitting element 760 and measurement object 53 and a second wave plate 708 arranged between the beam-splitting element 760 and the reference object 61. Interferometer 751 does not, however, include an additional wave plate in the objective assembly 758. Instead, the detector assembly 762 includes a single wave plate 710 (e.g., a quarter wave plate having its optical axis arranged at 0°) arranged between the beam-splitting element 765 and polarizer element 769. Furthermore, both polarizers 768 and 769 of detector assembly 762 have their optical axes arranged at 45°. In this configuration, the wave plate 710 introduces a phase shift between the constituent components of the beam portion reflected by beam splitter 765.

### Acquiring Interference Signals

As explained in the previous section, the coherence scanning interferometry systems utilize two detectors aligned to simultaneous image the same surface of an object, in which there is a relative phase shift between the information acquired by the first detector and the information acquired by the second detector. While various phase shifts can be introduced between the interferometry signals recorded at the first detector relative to the second detector, there are benefits, in certain implementations, of acquiring the data from each detector in phase-quadrature. In phase-quadrature, simultaneously acquired interferograms obtained at the first detector and the second detector have a relative phase offset between them of about 90°.

For example, an advantage of acquiring the interferometry data in phase-quadrature is that it provides a straightforward technique for canceling periodically occurring vibrational errors in the interferometry system. In particular, certain vibrational errors in interferometry systems manifest themselves as surface profile ripples having a frequency that is about twice the frequency of the fringes of the interferometry signals themselves. These vibrational errors can arise for various reasons including, for example, unexpected scan-motion behavior or coupling of external vibrations into the interferometry system—such as those produced by motors, pumps, or other machinery. By creating two copies of the interferometry signal obtained for the same range of OPD, in which one copy is phase-shifted relative to the other by about 90°, the vibrational error may be canceled when information obtained from the two signals is combined, for example, by averaging topography information obtained from each interferometry signal. Similarly, other errors having frequencies that are multiples of twice the interferometry fringe frequency may also be canceled using this technique. Thus, simultaneously recording low coherence interferometry signals in phase-quadrature for the same image point may suppress deviations due to relatively high-frequency vibrational errors (e.g., about 10% or more of the frame rate for the detector) and other errors related to the scan increment. For cyclic errors occurring from other causes, different phase shifts may be applied between the simultaneously acquired interferograms. For example, certain types of cyclic errors related to variations in the light intensity (intensity offsets and amplitude errors) during the data acquisition scan may be canceled by introducing a phase shift of about 180° between the simultaneously acquired interference signals. Though adding particular phase shifts between simultaneously acquired interferograms may reduce particular error modes, a phase shift of 0° may also be used simply to reduce the presence of random noise.

The simultaneous acquisition of phase-shifted low coherence interference signals may be further modified to enhance the speed at which data is acquired by the interferometry system. For example, the two detectors in the interferometer may sample intensity values of the interference signals at a rate that is sparse compared to the rate at which fringes of the interference signals move, i.e., the rate of translation of the reference object or measurement object. In some implementations, sampling of the interference signals occurs at a sub-Nyquist rate. The Nyquist rate is understood as corresponding to the lower bound at which a signal may be sampled without aliasing. For the present disclosure, the Nyquist rate is equal to two camera frames per interference cycle. Examples of sub-Nyquist sampling include the acquisition of intensity values at scan intervals that are greater than one-quarter of a wavelength of the interference signals being sampled.

The scan intervals between acquisitions of the intensity values (i.e., distance between subsequent OPDs at which data intensity values are acquired) can be uniform or non-uniform. For example, in some implementations, the two detectors may be operable to simultaneously acquire a first pair of interferograms nominally in quadrature followed by a short scan interval (e.g., within the length of a single fringe) and then simultaneously acquire a second pair of interferograms also nominally in quadrature. Subsequently, a longer scan interval (e.g., over the length of multiple fringes) may take place prior to the next pair of simultaneous interferogram acquisitions. This technique is referred to as “punctuated” data acquisition. In some cases, the sequential pairs of interferograms acquired at each detector are obtained in neighboring camera frames of the detector. In such instances, the minimum separation time between each acquisition of the sequential pair is determined based on the shutter time of the detector and/or the modulation rate of the light source.

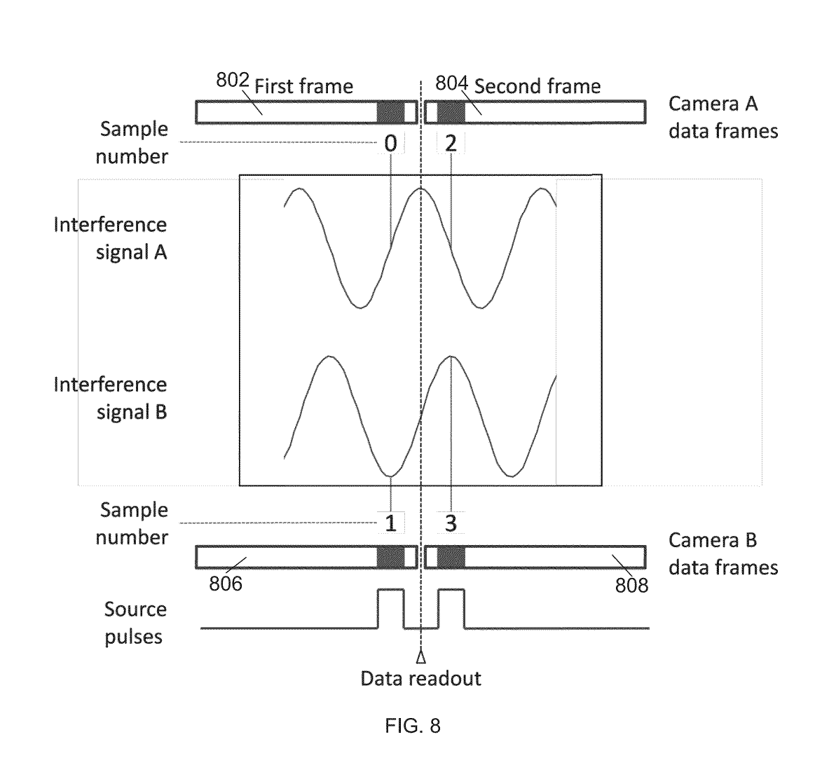

FIG. 8 is a schematic that illustrates the principle behind punctuated data acquisition. Two detectors, camera A and camera B, are used to simultaneously sample interference signals in quadrature. Camera A receives an incident beam that results in interference signal A, whereas camera B receives an incident beam that results in interference signal B. As shown in FIG. 8, interference signals A and B are in phase-quadrature. The bar 802 and bar 804 each correspond to the frame integration time for a single frame of detector A. Similarly, the bar 806 and bar 808 each correspond to the frame integration time for a single frame of detector B. Accordingly, FIG. 8 shows a period over which each detector processes two frames. In the present example, the frames of detector A are synchronized with the frames of detector B, so that a pair of frames between the two detectors begin and end at approximately the same time. The dashed line between each frame corresponds to the interline transfer point for each detector, during which the measured intensity values are shifted from the recording pixel. The light incident on the two detectors is modulated such that each detector is exposed to the incident light only for a portion of the frame time. This modulation can be achieved using various different techniques. For example, the source from which the test beam and reference beam are derived may be periodically toggled on and off. Alternatively, each detector may include a mechanical or electronic shutter mechanism that periodically blocks the incident light, provided that the incident beams are sufficiently intense to allow measurements to be made. In some implementations, the activation of the mechanical or electronic shutter may be controlled by the computer system coupled to the detector. Other mechanisms for modulation also may be used.

The shaded areas of the frames 802, 804, 806, and 808 in FIG. 8 indicate the portion of the frame time during which the detectors sample the interference signals (i.e., the time when light is present). Only one intensity value is obtained per frame. The detector is integrating throughout the frame time, but since light is only present for a short time, the effective integration time is short and confined to the shaded region. As shown in FIG. 8, detector A samples interference signal A at position 0, whereas detector B simultaneously samples interference signal B at position 1. For ease of viewing, the interference signals do not exhibit the envelope shape normally associated with low coherence scanning. The acquisition of the intensity values at positions 0 and 1 is followed by a short scan interval (e.g., by translation of the measurement object or reference object), at which point detector A and detector B again sample interference signals A and B at points 2 and 3, respectively. The two detectors thus acquire a first intensity pair [I₀, I₁] in quadrature, and a second intensity pair [I₂, I₃] in quadrature, in which the second pair of intensity values is shifted by about 180° relative to the first pair of intensity values. Before the next pair of intensity values is measured by the detectors, the interferometer system scans the OPD over an interval that is longer than the interval between the first two pairs of intensity values. The acquisition of the intensity values in each detector also straddles the interline transfer point. An advantage of using punctuated quadrature detection in this manner is that it provides four intensity samples over a relatively short period of time, in which the intensity values may be used to reconstruct a portion of the interference signal.

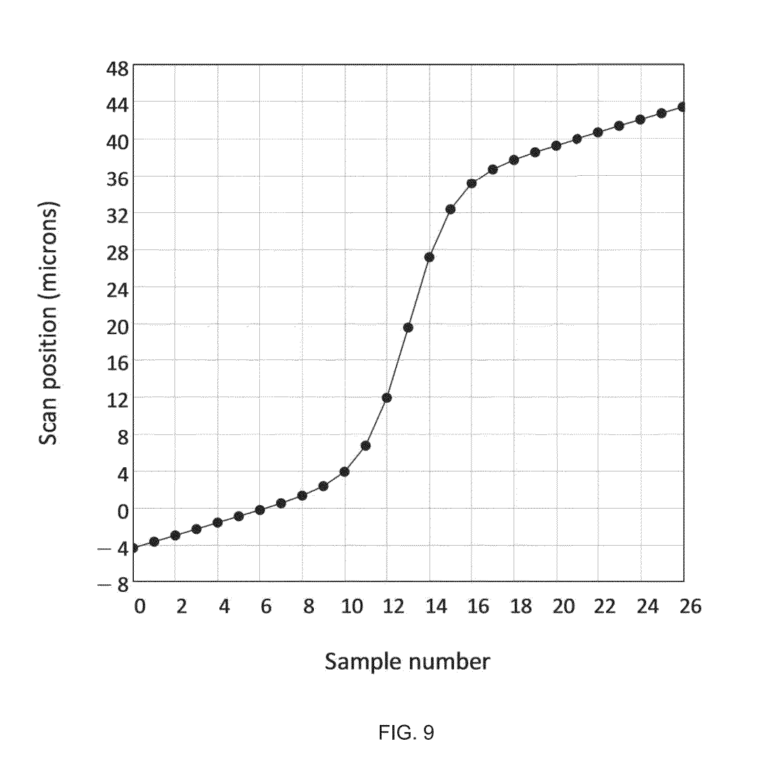

Non-uniform or variable scan intervals also may be useful to enhance the speed of data acquisition by the interferometry system. For example, when performing metrology on wafer solder bumps, the solder bump structure may allow for a reduction in total time necessary to acquire the intensity values of these interference signals by spacing the sample steps according to the expected feature height. This is called a nonlinear scan because the sampling density changes across the scan. That is, the sampling density may be increased along scan regions where features of interest are expected to occur and decreased between regions of interest. FIG. 9 is a plot of the sampling positions during a nonlinear scan. At each scan position a frame from both cameras is simultaneously acquired so the 26 positions shown in the figure represent 52 total frames. As shown in FIG. 9, the sampling density is high for scan positions between about −4 microns and about 4 microns, and for scan positions between about 32 microns and about 44 microns. In contrast, the scan velocity is increased so as to rapidly “skip-over” most of the uninteresting regions between about 4 microns and about 32 microns, resulting in a drop in sampling density, since the camera frame rate is constant.

### Analyzing Acquired Interference Signals

Once the intensity values are acquired by the two detectors of the interferometer, the computer control system that is coupled to the detectors analyzes the signals to reconstruct topography information about the measurement object. The analysis may be performed in two ways. The computer control system may process the interference signals obtained from the pixels of the first detector to produce first information about the measurement object, and independently process the interference signals obtained from the pixels of the second detector to produce second information about the measurement object. For example, the first and second information may include information such as a relative height map of the measurement object, a surface profile of the measurement object, or a film thickness map of one or more films on the measurement object. Alternatively, the first and second information can include a function indicative of how well a model signal matches the first or second interference signal. The first and second information then may be combined (e.g., averaged) to produce robust topography information about the measurement object, in which noise due to vibration errors or scan rate errors are suppressed.

Instead of analyzing the interference signals from the detectors separately, the computer control system may process the interferometry signals from the two detectors together to determine information about the measurement object, in which the only interferometry signals processed by the electronic processor are those from the interferograms measured by the first and second detectors. Further details on the different methods for processing the interference signals from the detectors are set forth below.

To accommodate the interferometer flexibility with scan increments (such as sub-Nyquist sampling, variable scan rates, and punctuated data acquisition) and to maximize the benefit of the phase quadrature information for improving resistance to vibration and scan-related errors, a modified least squares (LSQ) fitting of a model signal to the experimental CSI signals may be used. In some implementations, application of the LSQ fitting approach entails applying the fit to the interference signals measured by the first detector and the second detector to provide separate height information about the measurement object from each detector, and then averaging the independently calculated height information. Alternatively, in certain implementations, a global least-squares fit may applied to the interference signals to obtain the topography information about the measurement object.

### Least Squares Fitting: Basic Principles

Before discussing how LSQ may be modified to accommodate the non-uniform scan intervals and phase-quadrature information obtained from two detectors, it is beneficial to first review the basic principles of least-squares fitting method. Additional detail on LSQ may be found in U.S. Pat. No. 7,321,431, which is incorporated herein by reference in its entirety. In LSQ fitting, the experimental signal is compared with the real part of a complex phase-shifted model signal. An example of a model signal is a complex sine-cosine signal that allows for a variable carrier phase. The model signal may either be derived from first principles or determined empirically using a system characterization procedure. The system characterization method (about which further details also can be found in U.S. Pat. No. 7,321,431) allows for signals that may contain imperfections, distortions and offsets that are characteristic of the instrument, but can in principle account for the instrument interaction with a complex surface structure containing unresolved features or films too thin to be interpreted by envelope splitting.

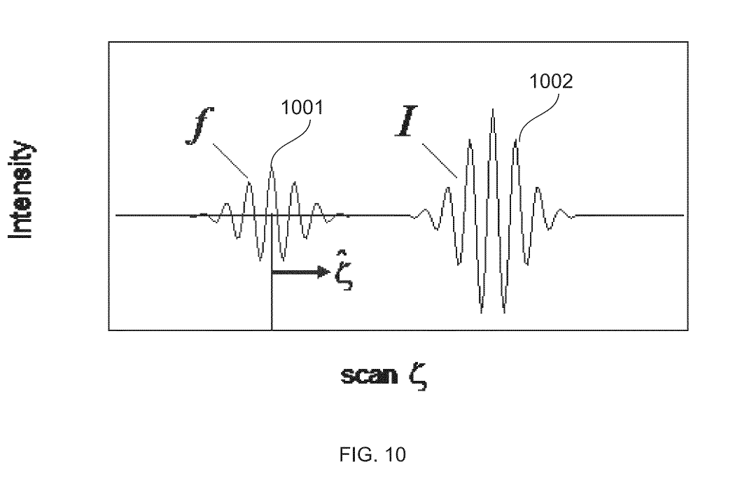

FIG. 10 is a plot showing a conceptual image of how LSQ fitting is used to fit a model function 1001 to an experimental interference signal 1002, in which the experimental interference signal 1002 is recorded from a single pixel of a detector over multiple scan positions. The variable ζ corresponds to the different interferometer scan positions as the OPD between the test beam and reference beam is varied. Each recorded intensity value of the experimental interference signal 1002 is associated with a different ζ. There is also a local scan coordinate ζ associated with the fitting function 1001. The fitting function 1001 may be based on a model of the expected signal and includes one or more variable parameters. At a given scan position, the variable parameters are varied to optimize the fit of the fitting function 1001 to the experimental interference signal 1002 using, for example, a least squares fit (though other optimization techniques may also be used). The scan position for which the fit is most successful locates the signal, and the optimized parameters at this point are the desired final result. A suitable fitting function may include a complex signal model T with separated constant offset C, average magnitude V and local phase φ at an angular interference fringe frequency K⁰ and may be expressed as follows:

ƒ(y,\hat{ζ})=C(y)+V(y)Re{T(\hat{ζ})exp[iφ(y)]}. (1)

The complex or analytical model signal T is qualitatively characterized by interference fringes modulated by a coherence envelope, and has imaginary and real parts that are sine-cosine versions of the same signal. For simplicity, the fitting function employs a single lateral coordinate y to show a dependence on the location within the image; although for full imaging there would of course be two lateral coordinates x, y.

With the experimental interference signal expressed as I, the location of fitting function ƒ is adjusted and (C, V, φ) are allowed to vary with the scan position ζ as needed to optimize the fit of ƒ to the signal I:

ƒ(y,\hat{ζ},ζ)=C(y,ζ)+V(y,ζ)Re{T(\hat{ζ})exp[iφ(y,ζ)]}. (2)

The LSQ method solves for the parameters (C, V, φ) by optimizing the fit within a tapered window w at each of the scan positions ζ. The optimization minimizes a square difference function at each ζ, in which the square difference function can be expressed as:

χ²(y,ζ)=∫w(\hat{ζ})[I(y,ζ+\hat{ζ})−ƒ(y,ζ,\hat{ζ})]²d\hat{ζ}. (3)

The window w places range limits on the local scan \hat{ζ} and allows us to concentrate on certain features of the signal with few computations. A tapered window such as the raised cosine (see Eq. (14), further on) is more forgiving of imperfections in the scan ζ than a simple square window. See, e.g., P. de Groot, “Derivation of phase shift algorithms for interferometry using the concept of a data sampling window,” Appl. Opt. 34(22) 4723-4730 (1995), incorporated by reference herein in its entirety.

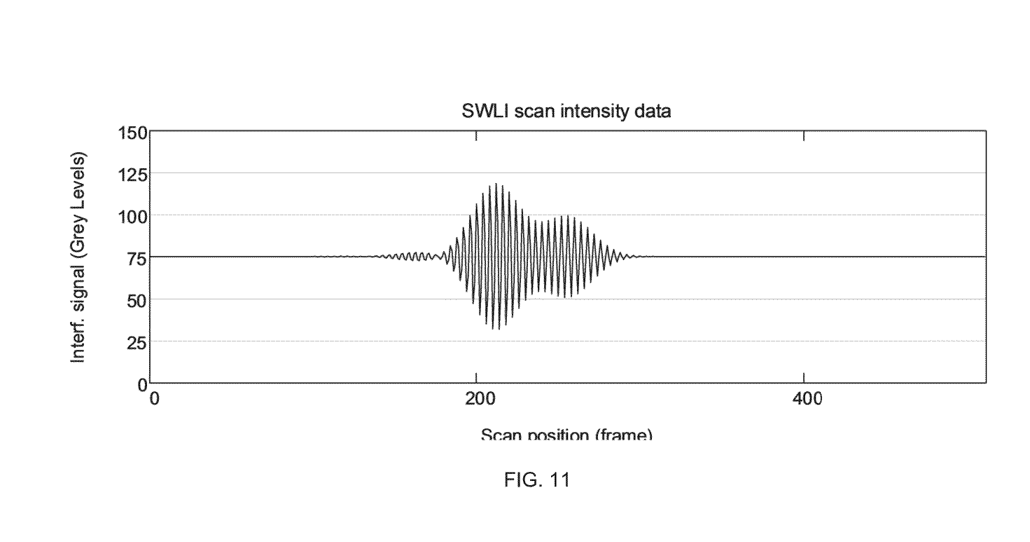

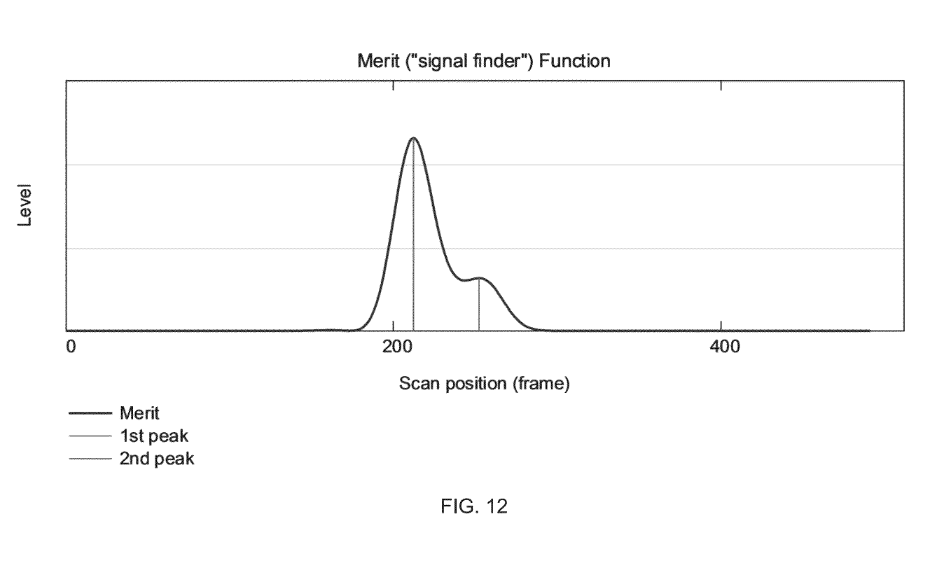

The best-fit solution for the signal strength V at each scan position ζ is expected to rise and fall according to the envelope of the experimental signal I, as illustrated in FIGS. 11 and 12. FIG. 11 is a plot of an example CSI signal recorded by a scanning interferometer for a 3-micron transparent thin film of SiO₂ formed on a Si substrate and using a 800 nm wavelength light source with 80-nm bandwidth. The scan position that minimizes the square difference χ² between the model signal and the experimental signal, while the signal strength V is strong locates the signal. FIG. 12 is a plot of a LSQ merit function for the CSI signal of FIG. 11, when the model is representative of an opaque surface. The merit function in the example of FIG. 12 equals the square of the measured fringe contrast between the CSI signal and the model function. As shown in FIG. 12, fitting the model function to the CSI signal results in two peaks corresponding to the locations of the top surface and substrate of a transparent film.

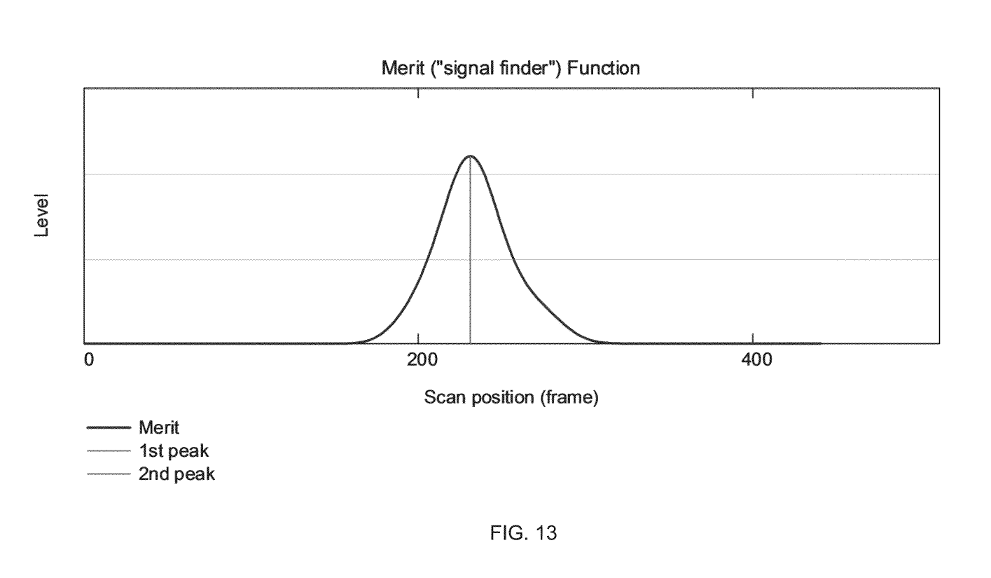

In some implementations, a model signal may be representative of complex surface structures having multiple interfaces, in which a single merit function peak is generated as opposed to multiple merit function peaks. For example, FIG. 13 is a plot of a LSQ merit function for the CSI signal of FIG. 11, when the model signal corresponds to a surface having the same basic thin film structure as the structure from which the CSI signal is obtained. The CSI signal is characterized by first performing a calibration step of the surface structure to obtain the model signal, and then using the model signal in subsequent measurements to compensate for the surface structure, assuming that the structure is reasonably constant across a surface. An advantage of using a model signal that is representative of the complex surface structure is that it reduces the probability of an incorrect identification of the optimal scan position should the merit function be minimized at a local minimum due to the present of an interface in the measurement object.

### Least Squares Fitting: Flexible Sampling of Intensity Values

In an actual scanning interferometer system, the experimental interference signals are typically recorded by a detector (e.g., a CCD camera) configured to capture multiple images, or camera frames, each frame being recorded at a different scan position. Thus, the interference signals I are sampled at a total of Y discrete lateral field positions y across the detector, in which the discrete lateral positions are indexed by the detector pixel number j=0 . . . (Y−1). For full imaging, there would also be discrete lateral positions indexed along the x direction. These signals are also sampled at discrete scan positions. In some implementations, the sample intensity values are uniformly distributed in the scan direction (i.e., uniform scan intervals), and the model signal T is sampled in an identical way for a direct comparison. However, to provide greater flexibility and accommodate variable scan rates in the interferometer system, the scan intervals of the sampled intensity values and/or of the model signal may be irregularly spaced (i.e., non-uniform scan intervals).

After data acquisition, we have for each pixel j a vector of experimental signal data I_{j,2} for corresponding scan positions ζ_{z} indexed by z=0, 1 . . . N−1. These scan positions may be irregularly spaced but are assumed to be known. The fitting function relies on a model signal T that is quantified for scan positions \hat{ζ}_{\hat{z}} indexed by \hat{z}=0, 1 . . . \hat{N}−1. The \hat{N} value is the number of discrete data points over which the fitting function is compared to the experimental signal. Usually, \hat{N} is an odd number so that for uniform sampling, there is a model signal point at the center flanked by the same number of points to either side.

The flexible sampling strategy is to determine the fit quality over a series of virtual evaluation scan positions ζₙ^{eval} for indices n=0, 1 . . . N^{eval}−1 that are disconnected from the acquisition scan. The evaluation scan can be a uniform grid with a sampling increment ζₛₜₑₚ^{eval} that is as small (or as large) as desired:

$${ζ}_{n}^{eval} = ( n - \frac{{N}^{eval} - 1}{2} ) {ζ}_{step}^{eval} \qquad ( 4 )$$

In traditional LSQ, this evaluation grid is tied to the experimental scan positions ζ_{z}. Here, evaluations are instead allowed to occur at scan positions other than those corresponding to the recorded intensity value data points.

To determine the quality of fit of the model signal to the experimental data for a specific evaluation scan position ζₙ^{eval}, the first step is to locate the experimental scan position that most closely matches the evaluation scan position:

z_{center}(n)=z index that minimizes (ζ_{z}−ζₙ^{eval}) for this n (5)

In some special cases such as punctuated acquisition, there may be an interest in making the central position z_{center} coincident with specific data points, such as points where z is even or odd or restricted to some range. See, e.g., L. L. Deck and P. J. de Groot, “Punctuated quadrature phase-shifting interferometry,” Optics Letters 23(1), 19 (1998), incorporated herein by reference in its entirety. Once the position z_{center} is identified, a portion of the intensity data may be extracted as follows:

Î_{n,\hat{z}}=I_{j,Z(n,\hat{z})} (6)

where

Z(n,\hat{z})=z_{center}(n)+\hat{z}−Δ (7)

and where the j dependence of the subvector Î is dropped only to simplify the notation as viewed. The offset Δ is the number of points to the left or to the right of the center point in the evaluation, and may be given by

$$Δ = \{ \begin{matrix}0 & thin films \\ round ( \frac{\hat{N} - 1}{2} ) & all other modes\end{matrix} \qquad ( 8 )$$

where “thin films” refers to thin layers of material formed on a substrate surface (See, e.g., U.S. Pat. No. 7,298,494, incorporated herein by reference in its entirety). An implicit assumption is that the experimental data are more or less evenly distributed to either side of the center of the scan. For many situations, it is useful although not essential to have N be an odd number. In other cases, for example when the data arrive in pairs (e.g., in punctuated data acquisition), \hat{N} is preferably an even number.

The model signal T_{n,\hat{z}} is calculated for the following scan positions:

\hat{ζ}_{n,\hat{z}}=ζ_{Z(n,\hat{z})}−ζₙ^{eval}. (9)

Calculating the model signal values T_{n,\hat{z}} follows from a complex inverse Discrete Fourier Transform (DFT) of the frequency-domain version qᵥ^{sys} of the model signal

$${T}_{n , \hat{z}} = {\sum }_{v = vmin}^{vmax} {q}_{v}^{sys} exp [ - i {\hat{ζ}}_{n , \hat{z}} {K}_{v} ] , \qquad ( 10 )$$

where Kᵥ refers to the frequency values (e.g., in units of radians of phase per micron of scan) within a bandwidth defined by the index range v=vmin, . . . vmax. The variables vmin and vmax are determined for a region of interest (ROI) in the spectrum that one desires to include in the reconstruction of the model signal T. The qᵥ^{sys} values follow from either a theoretical model or a model based on characterization of the system as described in more detail later in this disclosure.

Using the discrete subvectors Î and T, the square difference function of Eq. (3) becomes

$${χ}_{n}^{2} = {\sum }_{\hat{z} = 0}^{\hat{N} - 1} {( {\hat{I}}_{n , \hat{z}} - {f}_{n , \hat{z}} )}^{2} {w}_{\hat{z}} \qquad ( 11 )$$

where

ƒ_{n,\hat{z}}=Cₙ+Re[VₙT_{n,\hat{z}}exp(iφₙ)]. (12)

The window function w for the χ² can be any appropriate tapered weighting function. For example, a raised cosine window can be expressed as:

$${w}_{\hat{z}} = 0.5 + 0.5 cos ( \frac{{\hat{ζ}}_{z} - {\hat{ζ}}_{offset}}{{\hat{ζ}}_{width}} ) \qquad ( 13 )$$

where the window width \hat{ζ}_{width} is a bit wider than the total length of the model signal scan range

$${\hat{ζ}}_{width} = ( {\hat{ζ}}_{\hat{N} - 1} - {\hat{ζ}}_{0} ) ( 1 + \frac{2}{\hat{N} - 1} ) \qquad ( 14 )$$

and the offset \hat{ζ}_{offset} is used to shift the window to the right

$${\hat{ζ}}_{offset} = \{ \begin{matrix}( {\hat{ζ}}_{\hat{N} - 1} - {\hat{ζ}}_{0} ) \text{/} 2 & thin films \\ 0 & all other modes\end{matrix} \qquad ( 15 )$$

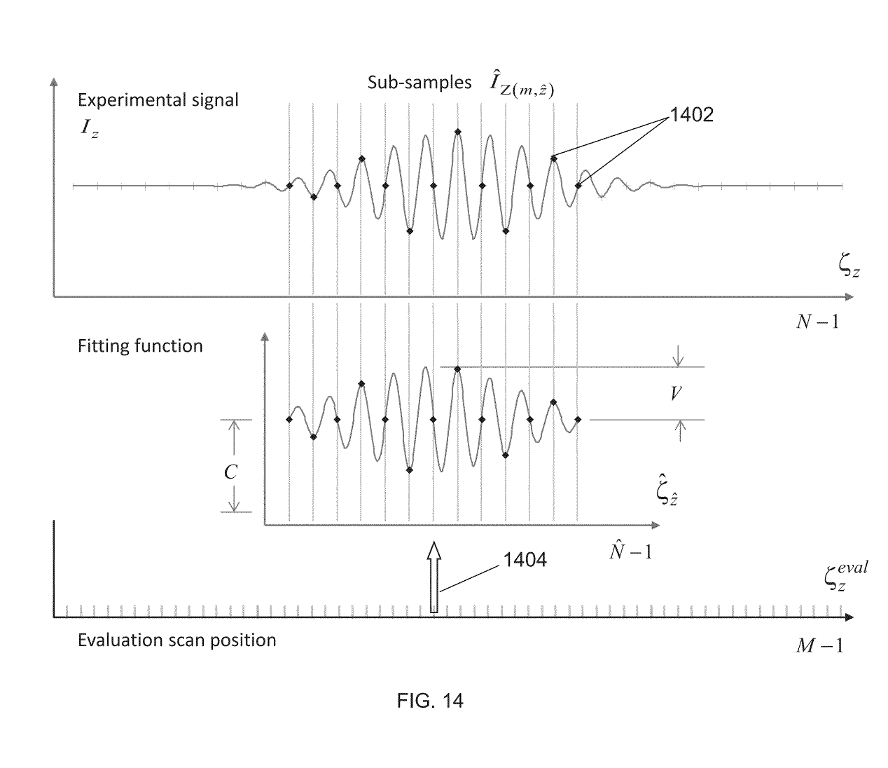

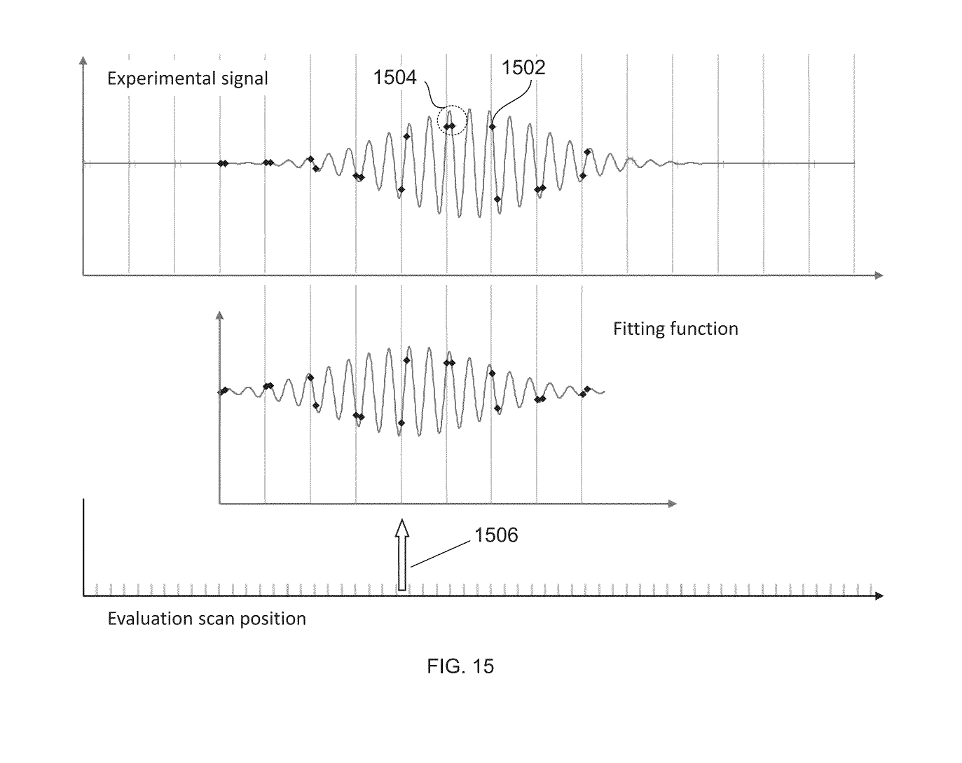

FIGS. 14 and 15 illustrate how the experimental signals are sampled and compared to the fitting function for both uniform and non-uniform data sampling. FIG. 14 is a dual plot that illustrates an example of uniform data sampling, in which the experimental data is sampled at a lower rate (4/3 samples per fringe) than the evaluation rate (4 samples per fringe), for example, by a factor u:

u=ζₛₜₑₚ/ζₛₜₑₚ^{eval}. (16)

The top plot in FIG. 14 depicts an outline of an interference signal sampled by a detector at discrete scan positions ζ_{z}. The different sampled values are represented by points 1402 in the plot. The bottom plot in FIG. 14 depicts the real part of the fitting function quantified for scan positions \hat{ζ}_{z}. As a result of the window function, the region of the fitting function that is evaluated is narrowed relative to the original experimental signal. The arrow 1404 indicates the evaluation scan position ζₙ^{eval} for the n at which the fitting function is compared to the experimental data intensity values. As shown in the example of FIG. 14, the factor u is equal to 3 (i.e., the interval between scan positions ζ_{z} is three times greater than the interval between the evaluation positions ζₙ^{eval} for each n) and the experimental signal data sampling is what we would refer to as “3× sub Nyquist,” meaning that the increment in terms of phase is three times the typical π/2 step between camera frames. The evaluation scan, which is a virtual construct, continues in this example to use the π/2 step even though the actual sampling is 3π/2. The number of samples \hat{N} N in the LSQ evaluation is 13. Other sub-Nyquist sampling ratios are also possible. For example, the experimental data sampling may proceed at any rate between 2 and 15 times the phase step between camera frames. Other rates may be used as well.

Note that in the example shown in FIG. 14, the evaluation steps are finer than the data acquisition steps. In other implementations, however, the evaluation steps may be identical in size to the data acquisition steps or greater than the data acquisition steps. For example, data processing may be sped up in some implementations if the evaluation steps are larger than the data acquisition steps.

In punctuated acquisition of data intensity values, there is a pair of successive acquisitions rapidly following each other, followed by some delay until the next acquisition pair. FIG. 15 is a dual plot that illustrates a simulated example of an experimental coherence interference signal sampled using a non-uniform data sampling procedure, specifically punctuated data acquisition, and a simulated fitting function for the acquired data. The top plot in FIG. 15 depicts an outline of the simulated interference signal sampled by a detector at discrete scan positions ζ_{z}. The different sampled values are represented by points 1502 in the plot are grouped into signal pairs 1504, in which the sampled intensity values of each signal pair 1504 are spaced on the scan axis by a close separation ζₛₜₑₚ^{short}. The signal pairs are spaced apart from each other by a longer scan interval ζₛₜₑₚ^{long}. The bottom plot in FIG. 15 depicts the real part of the fitting function quantified for scan positions \hat{ζ}_{\hat{z}}. As a result of the window function, the region of the fitting function that is evaluated is narrowed relative to the original experimental signal. The arrow 1506 indicates the evaluation scan position ζₙ^{eval} for the n at which the fitting function is compared to the experimental data intensity values.

The experimental scan positions can be expressed as

$${ζ}_{z} = {ζ}_{step}^{short} int ( \frac{z + 1}{2} ) + {ζ}_{step}^{long} int ( \frac{z}{2} ) \qquad ( 17 )$$

where int( ) returns only the integer portion of the argument (i.e., the function always rounds down to the nearest integer value). Punctuated data sampling is a special case for which the equation for determining z_{center} (Eq. (5)) requires using an even value for z and an even value for \hat{N} that represents an odd number of data pairs. Then the experimental scan position that most closely matches the evaluation scan position can be expressed as:

z_{center}(n)=even value for z index that minimizes (ζ_{z}−ζₛₜₑₚ^{eval}) for this n (18)

Regardless of the data sampling strategy (e.g., uniform, sub-Nyquist, punctuated, or variable), the discrete square-difference function of Eq. (11) after substituting Eq. (12) is

$${𝒳}_{n}^{2} = {\sum }_{\hat{z} = 0}^{\hat{N} - 1} {\{ {\hat{I}}_{n , \hat{z}} - {C}_{n} - Re [ {V}_{n} {T}_{n , \hat{z}} exp ( {iϕ}_{n} ) ] \}}^{2} {w}_{\hat{z}} . \qquad ( 19 )$$

This expands to

$${𝒳}_{n}^{2} = {\sum }_{\hat{z} = 0}^{\hat{N} - 1} {[ Re ( {\hat{I}}_{n , \hat{z}} ) - {C}_{n} {V}_{n} cos ( {ϕ}_{n} ) Re ( {T}_{n , \hat{z}} ) + {V}_{n} sin ( {ϕ}_{n} ) Im ( {T}_{n , \hat{z}} ) ]}^{2} {w}_{\hat{z}} . \qquad ( 20 )$$

Defining a solution vector

$${Λ}_{n} = [ \begin{matrix}{C}_{n} \\ {V}_{n} cos ( {ϕ}_{n} ) \\ {V}_{n} sin ( {ϕ}_{n} )\end{matrix} ] , \qquad ( 21 )$$

we rewrite Eq. (20) as

$${𝒳}_{n}^{2} = {\sum }_{\hat{z} = 0}^{\hat{N} - 1} {[ Re ( {\hat{I}}_{n , \hat{z}} ) - {( {Λ}_{n} )}_{0} - {( {Λ}_{n} )}_{1} Re ( {T}_{n , \hat{z}} ) + {( {Λ}_{n} )}_{2} Im ( {T}_{n , \hat{z}} ) ]}^{2} {w}_{\hat{z}} . \qquad ( 22 )$$

As a simplification, for the moment define

T_{Re}=Re(T_{n,\hat{z}}). (23)

T_{Im}=Im(T_{n,\hat{z}}) (24)

w=w_{\hat{z}} (25)

I=Î_{n,\hat{z}}. (26)

Then Eq. (22) takes on a more compact appearance as

χₙ³=Σ[I−(Λₙ)₀−(Λₙ)₁T_{Re}+(Λₙ)₂T_{Im}]²w (27)

where it is understood that the quantities I, T_{Re}, T_{Im}, w all depend on \hat{z} and that the summation is over all \hat{z}=0 . . . \hat{N}−1.

Continuing with this abbreviated notation, we seek a minimum for the square difference function χ² by setting to zero the partial derivatives

$$\begin{matrix}\frac{\partial {𝒳}_{n}^{2}}{\partial {( {Λ}_{n} )}_{0}} = - 2 \sum [ I - {( {Λ}_{n} )}_{0} - {( {Λ}_{n} )}_{1} {T}_{Re} + {( {Λ}_{n} )}_{2} {T}_{Im} ] w & ( 28 ) \\ \frac{\partial {𝒳}_{n}^{2}}{\partial {( {Λ}_{n} )}_{1}} = - 2 \sum [ {I}_{Re} - {( {Λ}_{n} )}_{0} - {( {Λ}_{n} )}_{1} {T}_{Re} + {( {Λ}_{n} )}_{2} {T}_{Im} ] {T}_{Re} w & ( 29 ) \\ \frac{\partial {𝒳}_{n}^{2}}{\partial {( {Λ}_{n} )}_{2}} = 2 \sum [ {I}_{Re} - {( {Λ}_{n} )}_{0} - {( {Λ}_{n} )}_{1} {T}_{Re} + {( {Λ}_{n} )}_{2} {T}_{Im} ] {T}_{Im} w , & ( 30 )\end{matrix}$$

Setting Eqs. (28)-(30) to zero, we have

ΣIw=Σ[(Λₙ)₀+(Λₙ)₁T_{Re}−T_{Im}(Λₙ)₂]w (31)

ΣIT_{Re}w=Σ[(Λₙ)₀T_{Re}+(Λₙ)₁T_{Re}²−(Λₙ)₂T_{Re}T_{Im}]w (32)

−ΣIT_{Im}w=Σ[−(Λₙ)₀T_{Im}−(Λₙ)₁T_{Re}T_{Im}+(Λₙ)₂T_{Im}²]w. (33)

These results lead to the matrix equation for the solution vector Λ:

Λₙ=ΞₙDₙ (34)

for

$$\begin{matrix}{Ξ}_{n} = {[ \begin{matrix}\sum w & \sum {T}_{Re} w & - \sum {T}_{Im} w \\ \sum {T}_{Re} w & \sum {T}_{Re}^{2} w & - \sum {T}_{Re} {T}_{Im} w \\ \sum {T}_{Im} w & \sum {T}_{Re} {T}_{Im} w & - \sum {T}_{Im}^{2} w\end{matrix} ]}^{- 1} \\ where & ( 35 ) \\ {D}_{n} = [ \begin{matrix}\sum I w \\ \sum {T}_{Re} I w \\ \sum {T}_{Im} I w\end{matrix} ] . & ( 36 )\end{matrix}$$

The results for the key parameters are:

Cₙ=(Λₙ)₀ (37)

Vₙ²=(Λₙ)₁²+(Λₙ)₂² (38)

φₙ^{m}=arctan [(Λₙ)₂/(Λₙ)₁] (39)

where the triple prime on the phase φₙ^{m} indicates that there is a three-fold uncertainty in the fringe order of the local phase φ, first across scan position, then from pixel to pixel, and finally overall with respect to an absolute starting position for the scan.

In principle, the matrix Ξₙ is a function of the evaluation scan position index n. However, since the matrix depends uniquely on the model signal T_{n,\hat{z}} and not on the experimental data, there are at most N^{eval} distinct values Ξₙ calculated prior to the experimental data acquisition. In the limit case where the model signal T_{n,\hat{z}} is not a function of the evaluation position, then all of the Ξₙ are identical and need not be calculated as a function of n. An intermediate case is the punctuated data acquisition of FIG. 15, for which there are distinct values of Ξₙ but there may also be a repeated pattern based on the ratio of the long step ζₛₜₑₚ^{long} to the short step ζₛₜₑₚ^{short}, particularly if this ratio forms an integer. The final case of interest is where we have complete knowledge of the actual scan motion, for example, using an additional sensor to record all motions, including accidental vibration. In this case, there are as many different values of Ξ as there are index positions n. Examples of such sensors can be found in U.S. Pat. No. 8,004,688 and U.S. Pat. No. 8,379,218, each of which is incorporated by reference herein in its entirety.

### Merit Function

The discussion to this point covers the LSQ algorithm for both uniform and non-uniform sampling. Next, a merit function is defined that can be used for locating the signal and determining the surface profile to account for the difference in the definition of the signal strength.

The definition of the merit function for locating the signal and determining the surface profile may depend on what one is trying to achieve. For example, if it is sufficiently certain that the peak signal strength corresponds to the signal location, then the simplest merit function is proportional to the square of the signal magnitude V that follows from Eq. (38). This is the so-called robust merit mode and can be expressed as follows:

Π_{j,n}^{robust}=V_{j,n}². (40)

This is a reasonable general-purpose merit function.

Alternatively, and more consistent with the ideal pattern match concept, a “best-fit” merit function can be defined that represents the goodness of fit between the model function and the interferometer signal as quantified by the inverse of the χ² minimization function of Eq. (20) after solving for the parameters (C, V, φ). In order to ensure that the signal magnitude V is still reasonably strong at the selected position, the signal magnitude is included in the definition for the best-fit merit function as follows:

$${Π}_{j , n}^{fine} = \frac{{V}_{j , n}^{2}}{{𝒳}_{min}^{2} + {𝒳}_{j , n}^{2}} . \qquad ( 41 )$$

The χₘᵢₙ² value in the denominator prevents accidental division by zero although other numbers may be used as well. The foregoing equation is called the fine merit mode, which may be more sensitive to random noise.

The determination of the measurement object surface height hⱼ amounts to locating the peaks of the merit function along the evaluation scan positions for each pixel of the detector. As in previous algorithms, several measurement modes may be utilized, each of which performs a different peak search. For example, when determining the top surface height profile of a test object, the rightmost or leftmost (depending on the scan direction) peak in the merit function along the direction of the scan is identified. If a fit based merit function is used, the location of the peak is the scan position corresponding to an optimum fit of the model function to the experimental signal. When determining film thickness, the strongest two peaks of the merit function may be used. For fit based merit functions, the location of each peak is a scan position corresponding to an optimum fit of the model function to the measurement signal.

Following identification of the peak or peaks (depending on the type of structure present, i.e., single or multi-interface), a quadratic interpolation is performed on three points centered around each peak value. Preferably, the points straddle the peak, but a user operating the interferometer may select different values. An alternative approach that is useful for opaque surfaces or other situations where multiple peaks are not expected is a centroiding method, in which the surface height hⱼ may be expressed as follows:

$${h}_{j} = \frac{{\sum }_{n} {ζ}_{n}^{eval} {Π}_{j , n}}{{\sum }_{n} {Π}_{j , n}} . \qquad ( 42 )$$

This equation provides an example of information about the measurement object that is independent of OPD, and is also obtained by processing the interferometry signals from one detector separately from the other detector.

In practice, the range of n values in the sum of Eq. (42) need only be sufficient to cover the fringe contrast envelope, for example, to the 10% contrast level. The n values should be centered at the position of the peak in the merit function. Either the robust merit function or the fine merit function may be used in Eq. (42).

### Determining the Model Signal

There are at least two ways to create the complex model signal T: from theory or from experiment. For model signals based on theory, it is sufficient in some cases to describe the signal theoretically as a carrier evolving at a frequency K⁰ modulated by a fringe contrast envelope V. A discretely-sampled complex model signal following this approach can be expressed as:

T_{\hat{z}}=V_{\hat{z}}exp[−i\hat{ζ}_{\hat{z}}K⁰]. (43)

A negative phase term in Eq. (43) indicates that an increasing scan corresponds to moving the interference objective away from the measurement object. This is opposite to an increase in surface height, which by definition corresponds to a positive change in phase. Eq. (43) is an idealized model of the kind of signal that might be expected in a scanning white light interferometry (SWLI) system.

For model signals based on experiment, empirical data acquired from the interferometry instrument itself may be used, in which case an inverse Discrete Fourier Transform (DFT) based on the frequency-domain representation qᵥ^{sys} of a typical signal:

$${T}_{n , \hat{z}} = {\sum }_{v = {v}_{min}}^{{v}_{max}} {q}^{sys} exp [ - i {\hat{ζ}}_{\hat{z}} {K}_{v} ] . \qquad ( 44 )$$

The q_{n,v}^{sys} is the average over multiple pixels of data of the frequency-domain representation of a typical interference signal for the interferometer system, acquired using a standard artifact, such as, for example, a SiC flat or other reference material.

The model signal acquired in this manner may have a complicated envelope and nonlinear phase, depending on the actual instrument characteristics. The variables vmin,vmax define the range of positive frequencies K (e.g., in units of radians of phase per micron of scan) within a region of interest (ROI) in the spectrum that one desires to include in the reconstruction of the model signal T.

### Dual Detector Data Acquisition—Averaged Final Heights

One approach to processing quadrature data acquisition with two detectors is to perform an LSQ analysis independently on the intensity signals I_{j,z}^{a}, I_{j,z}^{b} that are obtained from two detectors labeled a and b The merit functions then are averaged or, alternatively, the final height data hⱼ^{a}, hⱼ^{b} for each pixel of each detector are calculated and then averaged. The rational for averaging is that certain measurement errors (e.g., as a result of vibrations and/or scan motion) in CSI manifest dominantly as cyclic errors at twice the interference fringe frequency. Accordingly, two data sets acquired in phase quadrature will in principle cancel out the errors. An advantage of averaging the data in this manner is that, at a minimum, the final result obtained from the averaging is in no case worse, in terms of cyclic errors, than a single detector acquisition. Moreover, nearly complete cancelation of the errors may be possible even if the phase difference between the signals at the two detectors is not exactly 90°. The averaging approach has the additional benefit of not requiring precise calibration of the relative fringe contrast and intensity offsets for the two detectors.

### Dual Detector Data Acquisition—Global Fit (Quadrature LSQ)

A technique for processing the data from each detector that is an alternative to averaging the data includes applying a global fit to the data from each detector. For such a global fit, additional information regarding the interferometer operation may be supplied, including, for example, a determination of the nominal phase quadrature. For this quadrature LSQ method, let us assume that the phase difference θ between the two detectors is at least known, even if it is not exactly 90°, and let us assume further that the signals from the two detectors have been normalized with respect to each other on a pixel-by-pixel basis so that they have the same fringe visibility V and offset D. Then the two fitting functions corresponding to the signals I_{j,z}^{a}, I_{j,z}^{b} are

ƒ_{n,\hat{z}}^{a}=Cₙ+Re[VₙT_{n,\hat{z}}^{a}exp(iφₙ)]. (45)

ƒ_{n,\hat{z}}^{b}=Cₙ+Re[VₙT_{n,\hat{z}}^{b}exp(iφₙ)] (46)

where

T_{n,\hat{z}}^{b}=T_{n,\hat{z}}^{a}exp(iθ). (47)

A global least-squares fit is the simultaneous minimization

χₙ²=Σ[I^{a}−(Λₙ)₀−(Λₙ)₁T_{Re}^{a}+(Λₙ)₂T_{Im}^{a}]²w+ . . . +Σ[I^{b}−(Λₙ)₀−(Λₙ)₁T_{Re}^{b}+(Λₙ)₂T_{Im}^{b}]²w (48)

where the example of Eqs. (23)-(26) has been followed to simplify the notation. It should be noted that the solution vector Λ is common to both signals for this global optimization technique.

The calculation now closely parallels Eqs. (28)-(39) because the derivatives of Eq. (48) form linear sums, and leads to the following results:

Λₙ=ΞₙDₙ (49)

for

$$\begin{matrix}{Ξ}_{n} = [ \begin{matrix}2 \sum w & \sum ( {T}_{Re}^{a} + {T}_{Re}^{b} ) w & - \sum ( {T}_{Im}^{a} + {T}_{Im}^{b} ) w \\ \sum ( {T}_{Re}^{a} + {T}_{Re}^{b} ) w & \sum [ {( {T}_{Re}^{a} )}^{2} + {( {T}_{Re}^{b} )}^{2} ] w & - \sum ( {T}_{Re}^{a} {T}_{Im}^{a} + {T}_{Re}^{b} {T}_{Im}^{b} ) w \\ \sum ( {T}_{Im}^{a} + {T}_{Im}^{b} ) w & \sum ( {T}_{Re}^{a} {T}_{Im}^{a} + {T}_{Re}^{b} {T}_{Im}^{b} ) w & - \sum [ {( {T}_{Im}^{a} )}^{2} + {( {T}_{Im}^{b} )}^{2} ] w\end{matrix} ] \\ and & ( 50 ) \\ {D}_{n} = [ \begin{matrix}\sum ( {I}^{a} + {I}^{b} ) w \\ \sum ( {T}_{Re}^{a} {I}^{a} + {T}_{Re}^{b} {I}^{b} ) w \\ \sum ( {T}_{Im}^{a} {I}^{a} + {T}_{Im}^{b} {I}^{b} ) w\end{matrix} ] . & ( 51 )\end{matrix}$$

In the limit case of perfect quadrature, θ=π/2, and T_{n,\hat{z}}^{b} is the complex conjugate of T_{n,\hat{z}}^{a}. Eq. (50) simplifies to

$${Ξ}_{n} = {[ \begin{matrix}2 \sum w & \sum ( {T}_{Re}^{a} - {T}_{Im}^{a} ) w & - \sum ( {T}_{Im}^{a} + {T}_{Re}^{a} ) w \\ \sum ( {T}_{Re}^{a} - {T}_{Im}^{a} ) w & \sum [ {( {T}_{Re}^{a} )}^{2} + {( {T}_{Im}^{a} )}^{2} ] w & 0 \\ \sum ( {T}_{Im}^{a} + {T}_{Re}^{a} ) w & 0 & - \sum [ {( {T}_{Re}^{a} )}^{2} + {( {T}_{Im}^{a} )}^{2} ] w\end{matrix} ]}^{- 1} \qquad ( 52 )$$

Further simplifications are also possible. For example, in some implementations, the real and imaginary parts of the model signal are contrived to be identical in magnitude, which would cause two other terms to drop out of Eq. (52), leading to a very compact calculation. Eq. (50) is nonetheless a more general and realistic formulation given that adjusting the instrument for exact phase quadrature is more difficult than simply evaluating the phase difference θ in a calibration step.

### Exemplary Applications

The low coherence interferometry methods and systems utilizing simultaneously acquired phase-shifted interference signals described above may be used for any of the following surface analysis problems: simple thin films; multilayer thin films; sharp edges and surface features that diffract or otherwise generate complex interference effects; unresolved surface roughness; unresolved surface features, for example, a sub-wavelength width groove on an otherwise smooth surface; dissimilar materials; polarization-dependent properties of the surface, such as birefringence; and deflections, vibrations or motions of the surface or deformable surface features that result in incident-angle dependent perturbations of the interference phenomenon. For the case of thin films, the parameter of interest may be the film thickness, the refractive index of the film, the refractive index of the substrate, or some combination thereof. Exemplary applications including objects and devices exhibit such features are discussed next.

### IC Packaging and Interconnect Metrology

Among other things, advances in chip scale packaging, wafer-level packaging, and 3D packaging for integrated circuits have led to shrinking feature sizes and large aspect ratios that create challenges for surface metrology applications, such as solder-bump metrology, through-silicon via (TSV) metrology, and re-distribution layer (RDL) metrology in terms of lateral feature resolution and efficiency. For example, although general coherence scanning interferometry (CSI) enables the measurement of surface structures having surface height differences between neighboring imaging pixels that are more than one-half wavelength without the fringe ambiguity of phase-shifting interferometry, CSI may be limited due to its speed and vibration tolerances. Use of the systems and methods discussed herein in solder-bump, TSV, and RDL metrology offers the benefits of coherence scanning interferometry while improving acquisition speed and reducing noise due to vibration and other scan-related errors.

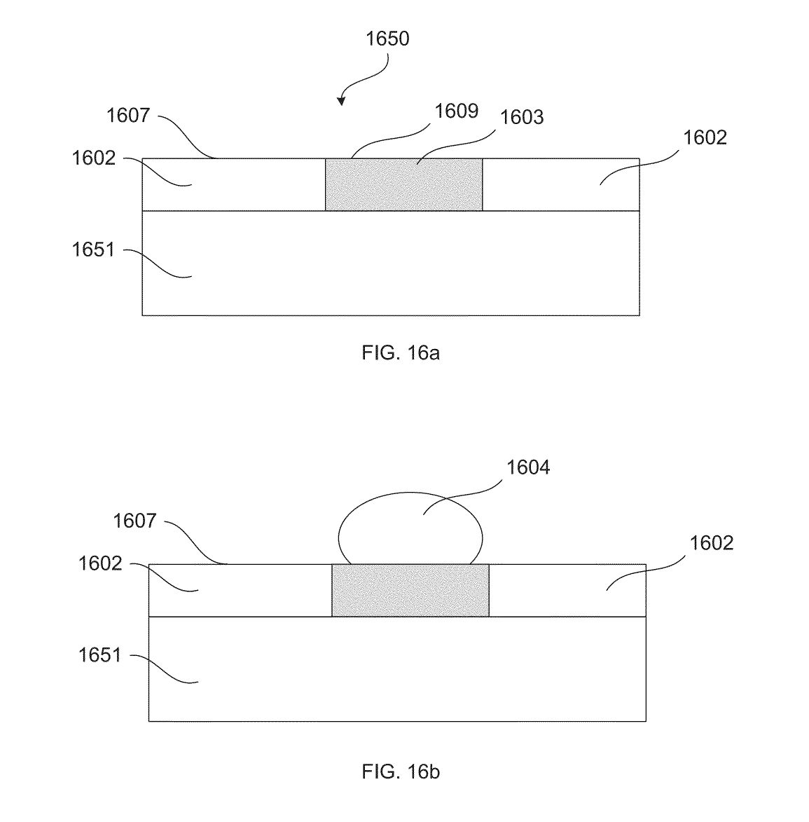

Referring to FIGS. 16a and 16b, a structure 1650 is exemplary of a structure produced during solder bump processing. Structure 1650 includes a substrate 1651, regions 1602 non-wettable by solder, and a region 1603 wettable by solder. Regions 1602 have an outer surface 1607. Region 1603 has an outer surface 1609.

During processing a mass of solder 1604 is positioned in contact with wettable region 1603. Upon flowing the solder, the solder forms a secure contact with the wettable region 1603. Adjacent non-wettable regions 1602 act like a dam preventing the flowed solder from undesirable migration about the structure. It is desirable to know spatial properties of the structure including the relative heights of surfaces 1607, 1609 and the dimensions of solder 1604 relative to surface 1602. Structure 1650 includes a plurality of interfaces between regions that may each result in an interference pattern. As shown in FIG. 1b6, the solder 1604 may have a spherical, quasi-spherical shape, or relatively flat. In some implementations, the solder may have a top-hat shape in which the base of the solder near the substrate is laterally broader than a top portion of the solder. The height of the solder features may range from about 5 microns to over 60 microns (e.g., about 10 microns, about 20 microns, about 30 microns, about 40 microns, or about 50 microns). The solder features may be separated from one another by distances from about 5 microns to 100 microns, as measured center to center (e.g., about 10 microns, about 20 microns, about 30 microns, about 40 microns, about 50 microns, about 60 microns, about 70 microns, about 80 microns, or about 90 microns). Furthermore regions 1602 and 1603 may be transparent or opaque to an interferometer source light wavelength.

The interferometry systems and methods disclosed herein can be used to evaluate the surface topology of the solder bumps, including the interfaces between layers in a reproducible and relatively fast manner that is resistant to vibration and/or scan-related errors, offering increased sample evaluation throughput. Examples of interferometer parameters that may be used for the foregoing or other applications are as follows: each detector may have a frame rate of about 30 frames/sec, 40 frames/sec, 50 frames/sec, 60 frames/sec, 70 frames/sec, 80 frames/sec, 90 frames/sec, 100 frames/sec, 200 frames/sec, or 500 frames/sec; a scan increment may be at least about 0.1 micron/frame, at least about 0.5 micron/frame, at least about 1 micron/frame, at least about 2 micron/frame, at least about 5 micron/frame, or at least about 10 micron/frame; a scan speed (e.g., along the z-direction in FIG. 1) may be at least about 1 micron/sec, at least about 5 micron/sec, at least about 10 micron/sec, at least about 20 micron/sec, at least about 30 micron/sec, at least about 40 micron/sec, at least about 50 micron/sec, at least about 60 micron/sec, at least about 70 micron/sec, at least about 80 micron/sec, at least about 90 micron/sec, or at least about 100 micron/sec; a sampling interval (e.g., distance between samples) may be at least about 3 quarter wavelength of the underlying interferometry signal, at least about 3 quarter wavelengths, at least about 5 quarter wavelengths, at least about 7 quarter wavelengths, at least about 9 quarter wavelengths, or at least about 11 quarter wavelengths; an absolute scan range along the z-direction may be at least about 10 microns, at least about 25 microns, at least about 50 microns, at least about 75 microns, at least about 100 microns, at least about 150 microns, at least about 200 microns, or at least about 250 microns; an acquisition time per field of view may be less than about 0.05 sec, less than about 0.1 sec, less than about 0.25 sec, less than about 0.5 sec, less than about 0.75 sec, or less than about 1 sec; a move and settle time between fields of view (e.g., laterally across the measurement object) may be less than about 0.05 sec, less than about 0.1 sec, less than about 0.25 sec, less than about 0.5 sec, less than about 0.75 sec, or less than about 1 sec; and a distance between lateral samples may be less than about 0.5 microns, less than about 1 micron, less than about 3 microns, less than about 5 microns, or less than about 10 microns. Other interferometer parameters may be used as well.

Depending on the parameters selected, the interferometer may be used to image multiple fields of view across whole wafers rapidly. For example, a dual-detector interferometer as described herein may image a 50 mm wafer, a 100 mm wafer, a 200 mm wafer, a 300 mm wafer, or a 450 mm wafer. Wafers may be imaged using the dual-detector interferometer at rates including, for example, at least about 10 wafers/hour, at least about 15 wafers/hour, at least about 20 wafers per hour, at least about 25 wafers/hour, at least about 30 wafers/hour, at least about 40 wafers/hour, at least about 50 wafers/hour, at least about 75 wafers/hour, or at least about 100 wafers/hour. The parameters set forth above and/or the processing algorithms used (e.g., height averaging or quadrature LSQ with or without merit function centroiding) may be further modified to balance desired noise reduction against a desired speed of data acquisition.

### Semiconductor Processing

The systems and methods described above can be used in a semiconductor process for tool specific monitoring or for controlling the process flow itself. In the process monitoring application, single/multi-layer films are grown, deposited, polished, or etched away on unpatterned Si wafers (monitor wafers) by the corresponding process tool and subsequently the thickness and/or optical properties are measured using the dual-detector interferometry system disclosed herein. The average of thickness (and/or optical properties), as well as wafer uniformity, of these monitor wafers are used to determine whether the associated process tool is operating with targeted specification or should be retargeted, adjusted, or taken out of production use.

In the process control application, single/multi-layer films are grown, deposited, polished, or etched away on patterned Si, production wafers by the corresponding process tool and subsequently the thickness and/or optical properties are measured with the interferometry system employing the sliding window LSQ technique disclosed herein. Production measurements used for process control typically include a small measurement site and the ability to align the measurement tool to the sample region of interest. This site may consists of multi-layer film stack (that may itself be patterned) and thus requires complex mathematical modeling in order to extract the relevant physical parameters. Process control measurements determine the stability of the integrated process flow and determine whether the integrated processing should continue, be retargeted, redirected to other equipment, or shut down entirely.

Specifically, for example, the interferometry systems and methods disclosed herein can be used to monitor devices and materials fabricated using the following equipment: diffusion, rapid thermal anneal, chemical vapor deposition tools (both low pressure and high pressure), dielectric etch, chemical mechanical polishers, plasma deposition, plasma etch, lithography track, and lithography exposure tools. Additionally, the interferometry system disclosed herein can be used to monitor and control the following processes: trench and isolation, transistor formation, as well as interlayer dielectric formation (such as dual damascene).

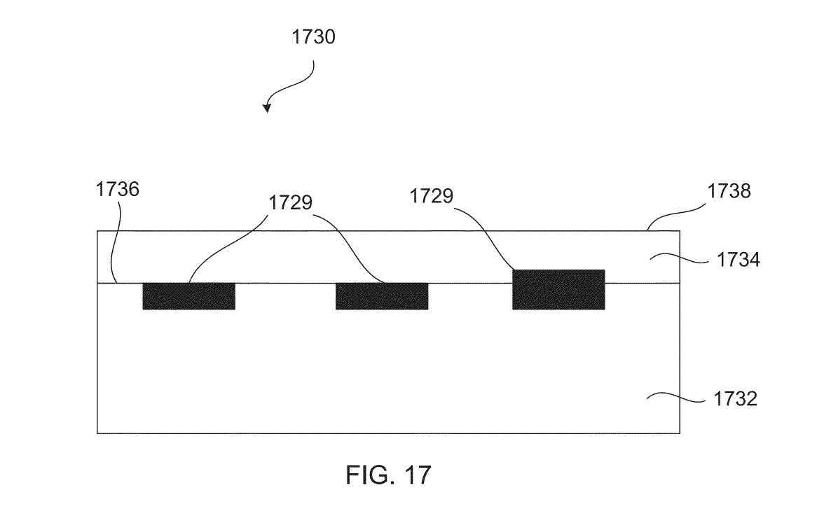

FIG. 17 is an example of an object 1730 that may be monitored during fabrication of a microelectronic device. Object 1730 includes a substrate, e.g., a wafer, 1732 and an overlying layer, e.g., photoresist layer 1734. Object 1730 includes a plurality of interfaces as occur between materials of different refractive index. For example, an object-surroundings interface 1738 is defined where an outer surface of photoresist layer 1734 contacts the environment surrounding object 1730, e.g., liquid, air, other gas, or vacuum. A substrate-layer interface 1736 is defined between a top surface of wafer 1732 and a bottom surface of photoresist layer 1734. A surface of the wafer may include a plurality of patterned features 1729. Some of these features have the same height as adjacent portions of the substrate but a different refractive index. Other features may extend upward or downward relative to adjacent portions of the substrate. Accordingly, interface 1736 may exhibit a complex, varying topography underlying the outer surface of the photoresist. During the photolithography process, the dual-detector low coherence scanning interferometer disclosed herein may be used to analyze the surface properties and interfaces of object 1730, such as the surface topology, the film thickness of the photoresist layer 1734, or the relative height of additional layers formed within object 1730.

### Simulations

Determining a spatial property of a measurement object using the coherence scanning interferometry systems and methods described herein is further described in the context of the following examples based on simulations of simultaneously measured phase-shifted interferometry signals. The simulations presented here were developed using the MathCad® computer simulation software from PTC of Needham, Mass. The measurement object was assumed to be a reference flat having an opaque single surface.

The following system parameters were assumed for the simulations: a center wavelength of the light source was set equal to 800 nm and a bandwidth of the illumination was set equal to 80 nm; the light was assumed to have a perfect Gaussian spectral profile in the wavenumber domain; the numerical aperture for the system was set equal to 0; the aggregate scanning distance over which the simulation operated was equal to 40 microns; the area of each detector (for a single detector arrangement and a dual-detector arrangement) was assumed to be equivalent to a mask that is 1 pixel long and 300 pixels wide; a signal width of the LSQ model signal was set equal to approximately 9 microns; the LSQ peak searches were implemented based on a quadratic interpolation of the merit function near the highest peak; the model signal was perfectly-known; the standard sampling rate was set equal to 100 nm/frame (i.e., four frames per fringe of the interference signal); a fringe visibility was assumed to be 100%; acquisition of the data was shuttered (i.e., there is no “bucket effect” such that the integration time is effectively zero); sampling of the data intensity values occurred at either the standard sampling rate or a sub-Nyquist rate, in which the sub-Nyquist multiplier is an integer times the standard sampling rate; for punctuated acquisition when using a dual detector system, phase opposition (i.e., adjacent intensity values) were phase-shifted by about 180 degrees and successive intensity values were acquired at a rate equal to twice the standard sampling rate; and the reference flat was assumed to be tilted in one direction to cover a height range of about 4 microns.

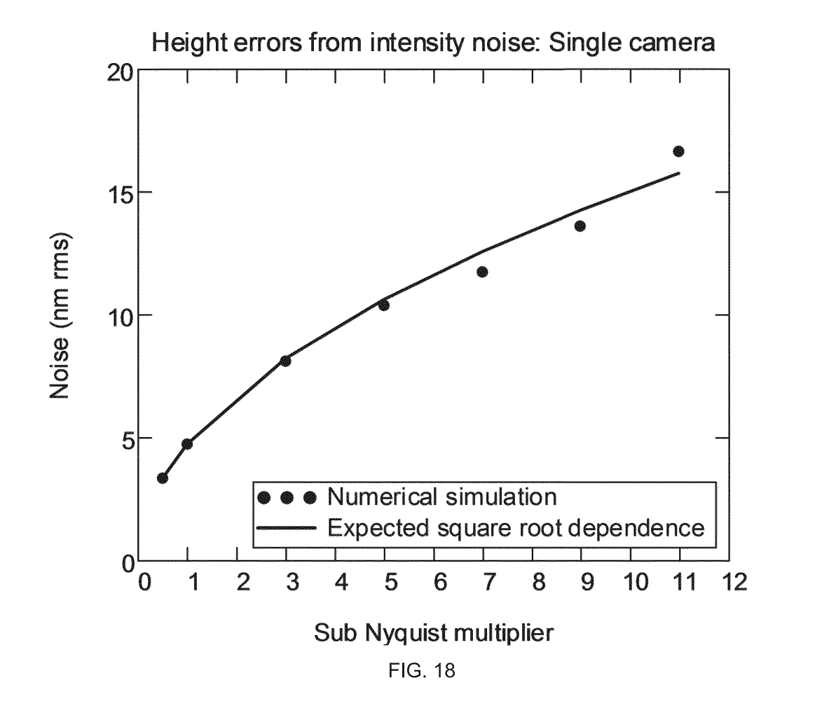

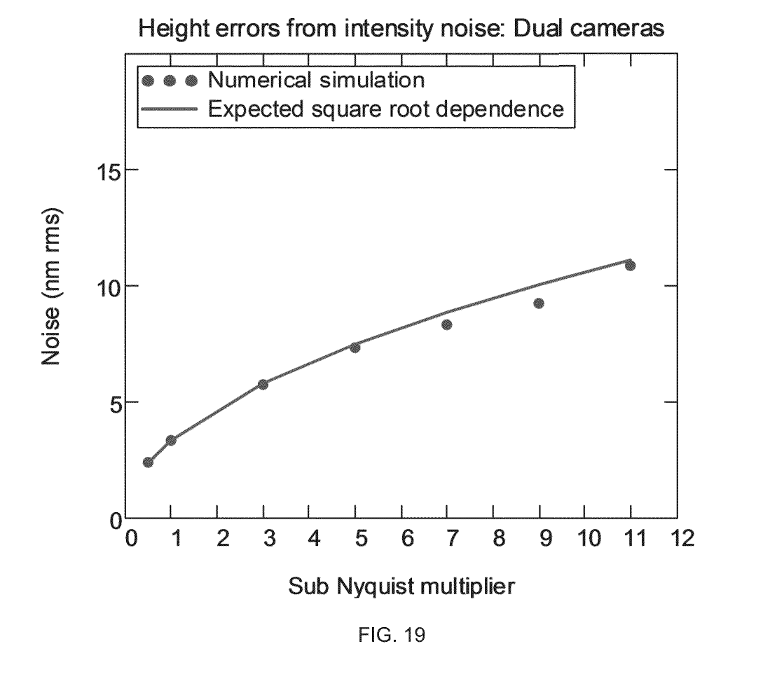

FIG. 18 is a plot that illustrates the effect of sparse sampling on the height noise for a single detector. FIG. 19 is a plot that illustrates the effect of sparse sampling on the height noise for a dual-detector system, in which the height information from the two detectors are averaged. As shown in FIG. 19, the level of rms noise for the dual-detector system is reduced by almost a factor of 2 for each different sub-Nyquist shown in FIG. 18.

It is worth noting that at 11× sub-Nyquist sampling in FIG. 18 for the single detector system, we begin running out of coherence envelope and the rms noise begins to deviate upward from the expected square root statistics. At 15× sub-Nyquist sampling, for example, there are only 5 data points spanning the coherence envelope for the 80-nm bandwidth light source, and the measurement essentially fails with a single camera.

### Height Errors Caused by Pure Sinusoidal Variation

Simulations involving errors caused by pure sinusoidal variations also were evaluated at 101 different vibrational frequencies ranging from zero to the detector frame rate. The amplitude of the vibrational disturbances in the simulations was set to 10 nm. The results were the average of the sensitivities for vibrational phase offsets of 0 and 90°.

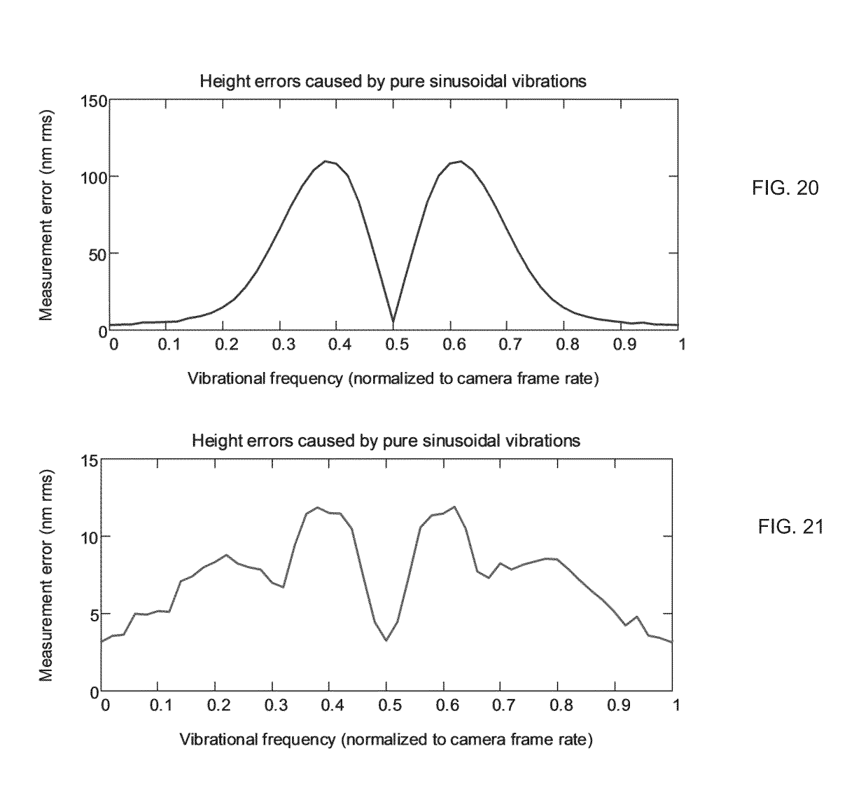

FIGS. 20-22 are plots of rms height measurement error caused by sinusoidal vibrations, in which the interference signal is also subject to sub-Nyquist sampling. FIG. 20 specifically shows a plot of the rms height measurement error versus sinusoid frequency for a single detector sampling the interference signal at a sub-Nyquist multiplier of 7×. In the absence of the sub-Nyquist sampling, the peak sensitivity scales with the ratio of the source bandwidth to the mean wavelength, as is typical in CSI. See, e.g., P. de Groot, “Coherence Scanning Interferometry,” in Optical Measurement of Surface Topography, edited by R. Leach, pp. 187-208 (Springer Verlag Berlin, 2011), incorporated herein by reference in its entirety. With sub-Nyquist sampling, the peak value remains, but the sensitivity curve broadens and accepts a wider range of vibrational frequencies, as shown in FIG. 20. The increase in peak width is equal to the sub-Nyquist multiplier. The breadth of the peaks demonstrates the difficulty of tuning the mechanics of the measurement loop so as to be near half the camera rate in order to avoid vibrational frequencies at the peak sensitivities.

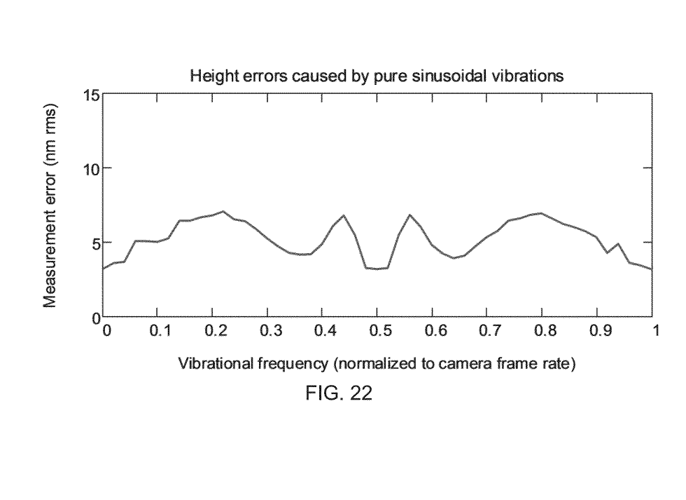

When switching to a dual-detector arrangement in which the height information from each detector is averaged, FIG. 21 shows a factor of 10 reduction in the measurement error caused by the sinusoidal vibration. In addition, applying quadrature LSQ (i.e., a global fit) results in a further factor of 2 reduction in the peak amplitude of the measurement error as well as a narrowing of the sensitivity peak, as shown in FIG. 22.

### Height Errors Caused by Pure Random Variation

Although the transfer function curves for pure sinusoidal vibrations of FIGS. 20-22 are informative, it is useful to test the algorithms in the presence of fully random vibrations uniformly distributed across all frequencies. To this end, MathCad simulations also were performed to determine the deviation of the measured flatness of a simulated reference flat tilted so as to reveal cyclic errors as well as systemic deformations over a O-micron height range.

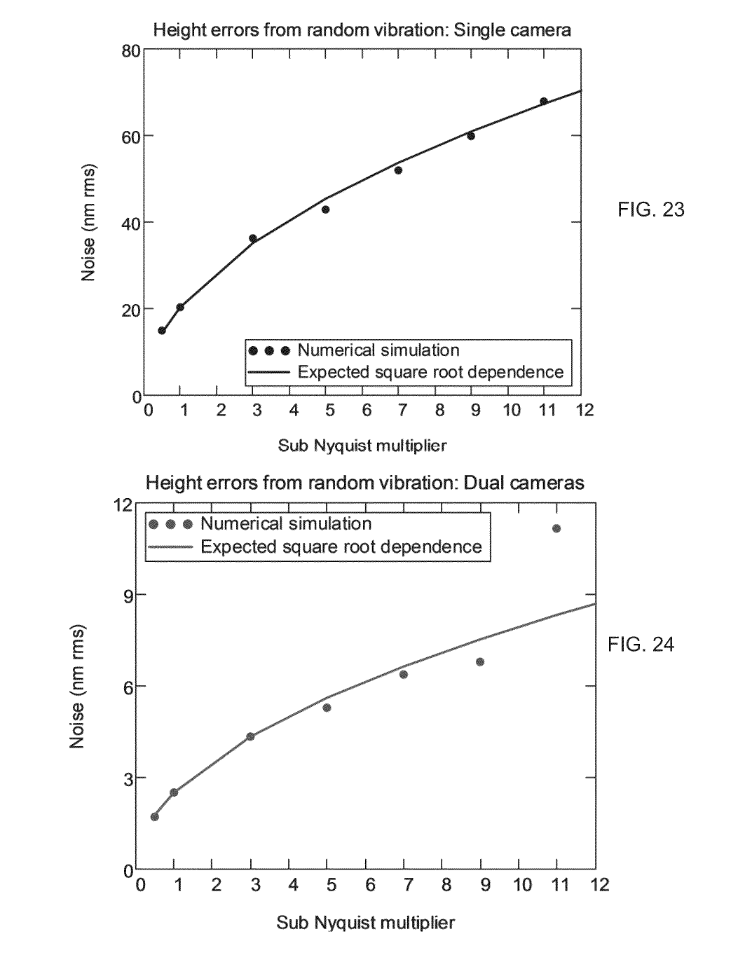

FIGS. 23 and 24 are plots of rms noise as a function of the sub-Nyquist multiplier and summarize the performance difference between a single-camera system and the dual camera system, when merit function centroiding is used to locate the signal peaks. For sub-Nyquist multipliers up to 9× (900 nm/frame), the improvement may be a reduction in rms noise by a factor of about 10. Once the sub-Nyquist multiplier reaches 11×, the rms noise for the dual-detector arrangement begins to deviate from the expected square root statistics, implying that a somewhat narrower bandwidth light source may be preferable at this sampling rate. For both the single and the dual camera systems, the dependence on sampling generally follows a quadratic curve, given that the bandwidth of the vibrational-error transfer curve broadens linearly with the sub-Nyquist multiplier, and the integrated noise increases as the root-sum-square of the noise contributions within this bandwidth.

If the actual scan positions ζ_{z} can be monitored or otherwise communicated to the LSQ algorithm, the flexible-scan formalism allows for complete correction of the height errors. This method is only effective if we include the χ² in the merit function calculation, as in Eq. (41). The scan information may be obtained, for example, by using a separate sensor dedicated to measuring scan position.

### Height Errors Caused by Incorrect Scan Rate

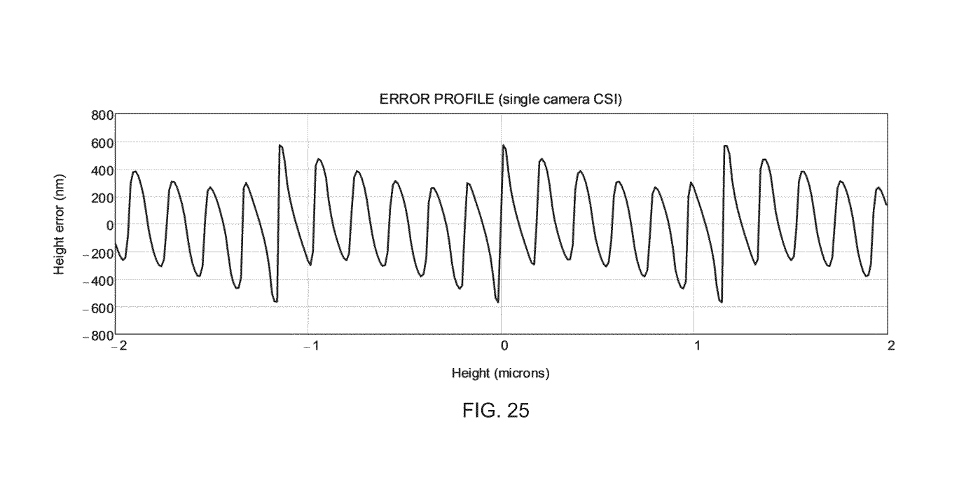

One concern when using LSQ, particularly for sub-Nyquist scans, is that the effective scan rate, as determined by the rate at which the interference fringes pass by, differs with respect to the model signal, or the effective scan rate is distorted by numerical aperture effects or surface slopes. Such variations can lead quite rapidly to errors. For example, FIG. 25 is a plot of height error as a function of height of the scan, and shows that for the relatively modest case of a 5% ramp rate miscalibration and a sub-Nyquist sampling multiplier of 11×, a substantial increase in error occurs. The sub-Nyquist multiple means that nearly three interference fringes are being skipped between data samples, which leads to an amplification of the mismatch of the measured intensity to the expected value.

To address the increased error, additional processing may be employed to infer the correct fringe rate with high accuracy by averaging the fringe rate over the field of view. The mean fringe rate could then be employed to revise the model signal. Alternatively, or in addition, the dual-detector arrangement may be employed to correct the increased error due to the scan mismatch.

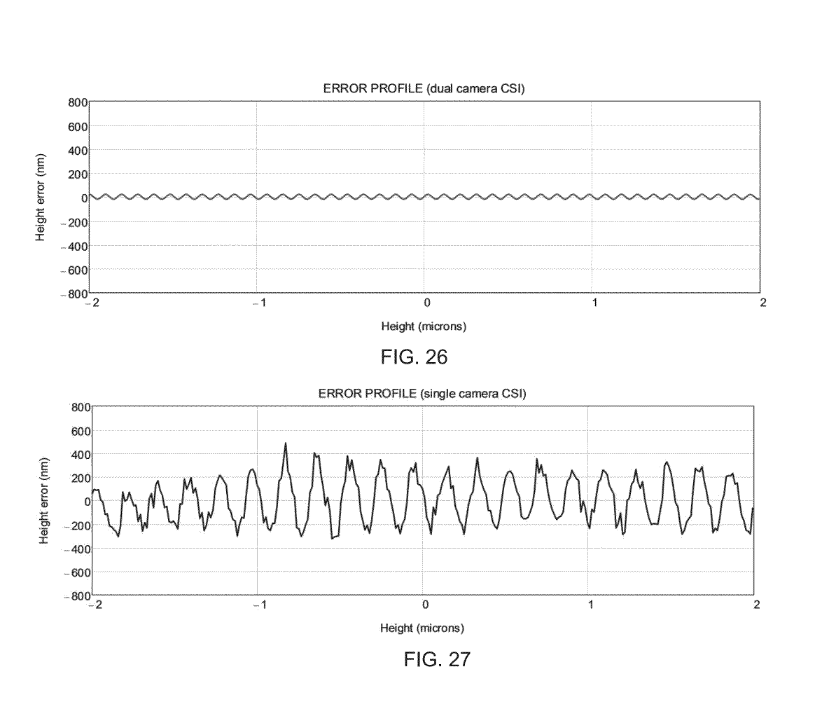

For example, FIG. 26 is a plot of height deviation as a function of height across the measurement object when quadrature LSQ with the height-averaging method is used. As shown in FIG. 26, it is evident that the two-cycle per fringe component is substantially compensated.

### Multiple Error Sources

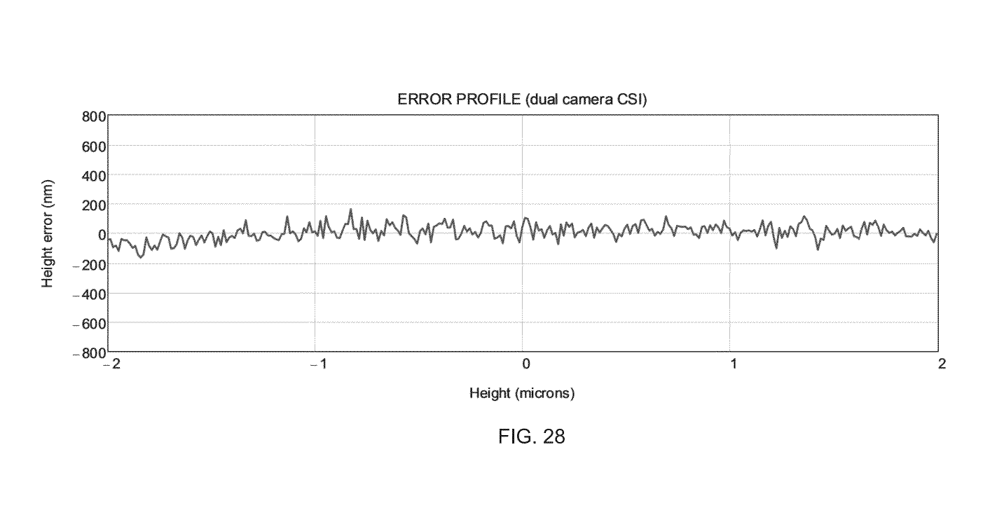

FIG. 27 is a plot of height error as a function of scan height for a simulated scan when multiple errors are combined in a single-detector system. FIG. 27 illustrates the height error caused by the combination of a 5% ramp rate miscalibration and 10 nm rms random noise (corresponding to 2 bit rms over a 256 bit dynamic range) at a sub-Nyquist sampling multiplier of 11× (1100 nm per camera frame) for a single detector. A interferometer system employing two phase-shifted detectors and utilizing the height averaging method based on merit centroiding may be applied to the same signal. For example, FIG. 28 shows that a surface topography repeatability of better than 100 nm can be obtained using the dual-detector arrangement at a sub-Nyquist sampling multiplier of 11× and in the presence of realistic error sources, such as a 5° quadrature calibration error. These results further illustrate the robustness of the dual-detector approach and the reduced need for careful calibration.

### Computer Implementation

Depending on the embodiment, the techniques and analyses described herein for processing simultaneously acquired phase-shifted interference signals, in which each interference signal is from a separate different detector, can be implemented using control electronics in an interferometer system, in which the control electronics are implemented through hardware or software, or a combination of both. The techniques can be implemented in computer programs using standard programming techniques following the methods and figures described herein. Program code is applied to input data to perform the functions described herein and generate output information. The output information (e.g., position information related to a relative position of a target object to the optical assembly) is applied to one or more output devices such as a display device. Each program may be implemented in a high level procedural or object oriented programming language to communicate with a computer system, or the programs can be implemented in assembly or machine language, if desired. In any case, the language can be a compiled or interpreted language. Moreover, the program can run on dedicated integrated circuits preprogrammed for that purpose.

Each such computer program may be stored on a storage medium or device (e.g., ROM, magnetic diskette, FLASH drive, among others) readable by a general or special purpose programmable computer, for configuring and operating the computer when the storage media or device is read by the computer to perform the procedures described herein. The computer program can also reside in cache or main memory during program execution. The analyses described herein can also be implemented as a computer-readable storage medium, configured with a computer program, where the storage medium so configured causes a computer to operate in a specific and predefined manner to perform the functions described herein.

Embodiments relate to interferometry systems and methods for determining information about a test object. Additional information about suitable low-coherence interferometry systems, electronic processing systems, software, and related processing algorithms is disclosed in commonly owned U.S. Pat. Nos. 5,600,441, 6,195,168, 7,321,431, 7,796,273, and U.S. patent applications published as US-2005-0078318-A1, US-2004-0189999-A1, and US-2004-0085544-A1, the contents of each of which are incorporated herein by reference in their entirety.

A number of embodiments have been described. Nevertheless, it will be understood that various modifications may be made without departing from the spirit and scope of the invention. Accordingly, other embodiments are within the scope of the following claims.

What is claimed is:

1. A low-coherence scanning interferometry system comprising:
an interferometry apparatus comprising a light source, an interferometer, a first detector, and a second detector, the apparatus configured to simultaneously measure, for each optical path length difference (OPD) of a sequence of OPDs between test light reflected from a test object and reference light, first and second phase-shifted interferograms corresponding to intensity patterns produced by interfering the test light reflected from the test object with the reference light on the first and second detectors, respectively, the test light and the reference light being derived from the light source,
each interferogram measured by the first detector defining a first set of interferometry signals corresponding to multiple transverse locations on the test object,
each interferogram measured by the second detector defining a second set of interferometry signals corresponding to substantially the same multiple transverse locations on the test object, wherein each interferometry signal in the second set is phase-shifted relative to a corresponding interferometry signal in the first set, every interferometry signal comprising a series of intensity values corresponding to the sequence of OPDs; and
an electronic processor coupled to the interferometry apparatus, wherein the electronic processor is configured to perform operations comprising: i) processing the first set of interferometry signals, independently from the second set of interferometry signals, to obtain first processed information about the test object over the multiple transverse locations; ii) processing the second set of interferometry signals, independently from the first set of interferometry signals, to obtain second processed information about the test object over the multiple transverse locations; and iii) combining the first processed information with the second processed information to determine the information about the test object with the reduced sensitivity to errors.

2. The scanning interferometry system of claim 1, wherein the light source is configured to provide an input light beam, and the system further comprises an objective assembly configured to convert the input light beam into the test light and the reference light, wherein the test light and the reference light have orthogonal polarizations states with respect to one another.

3. The scanning interferometry system of claim 2, wherein the objective assembly is further configured to introduce a phase-shift between constituent components of the test light and of the reference light.

4. The scanning interferometry system of claim 1, wherein the input beam has a linearly polarization state or is unpolarized.

5. The scanning interferometry system of claim 1, wherein each pixel of the first detector is aligned to substantially the same location on the test object as a corresponding pixel of the second detector.

6. A low-coherence scanning interferometry system comprising:
an interferometry apparatus comprising a light source, an interferometer, a first detector, and a second detector, the apparatus configured to simultaneously measure, for each optical path length difference (OPD) of a sequence of OPDs between test light reflected from a test object and reference light, first and second phase-shifted interferograms corresponding to intensity patterns produced by interfering the reference light with the test light reflected from the test object on the first and second detectors, respectively, the test light and the reference light being derived from the light source,
each interferogram measured by the first detector defining a first set of interferometry signals corresponding to multiple transverse locations on the test object,
each interferogram measured by the second detector defining a second set of interferometry signals corresponding to substantially the same multiple transverse locations on the test object, wherein each interferometry signal in the second set is phase-shifted relative to a corresponding interferometry signal in the first set, every interferometry signal comprising a series of intensity values corresponding to the sequence of OPDs; and
an electronic processor coupled to the interferometry apparatus, wherein the electronic processor is configured to perform operations comprising processing the interferometry signals to determine information, with reduced sensitivity to errors, about the test object, wherein the electronic processor is configured to process the interferometry signals only from the interferograms measured by the first and second detectors.

7. The scanning interferometry system of claim 6, wherein the light source is configured to provide an input light beam, and the system further comprises an objective assembly configured to convert the input light beam into the test light and the reference light, wherein the test light and the reference light have orthogonal polarizations states with respect to one another.

8. The scanning interferometry system of claim 7, wherein the objective assembly is further configured to introduce a phase-shift between constituent components of the test light and of the reference light.

9. The scanning interferometry system of claim 6, wherein the input light beam has a linearly polarization state or is unpolarized.

10. The scanning interferometry system of claim 6, wherein each pixel of the first detector is aligned to substantially the same location on the test object as a corresponding pixel of the second detector.

11. A low-coherence scanning interferometry method, the method comprising:
for each optical path length difference (OPD) of a sequence of OPDs between test light reflected from a test object and reference light in a scanning interferometer, simultaneously measuring two phase-shifted interferograms corresponding to intensity patterns produced by interfering the test light reflected from the test object with the reference light on respective first and second detectors, wherein the test light and the reference light are derived from a common source and wherein the sequence of OPDs spans a range larger than a coherence length of the common source,
the interferograms measured by the first detector defining a first set of interferometry signals corresponding to multiple transverse locations on the test object,
the interferograms measured by the second detector defining a second set of interferometry signals corresponding to substantially the same multiple transverse locations on the test object, wherein each interferometry signal in the second set is phase-shifted relative to a corresponding interferometry signal in the first set,
wherein every interferometry signal comprises a series of intensity values corresponding to the sequence of OPDs; and
using an electronic processor to process the interferometry signals to determine information about the test object with reduced sensitivity to errors, wherein the electronic processer performs operations comprising: i) processing the first set of interferometry signals, independently from the second set of interferometry signals, to obtain first processed information about the test object over the multiple transverse locations; ii) processing the second set of interferometry signals, independently from the first set of interferometry signals, to obtain second processed information about the test object over the multiple transverse locations; and iii) combining the first processed information with the second processed information to determine the information about the test object with the reduced sensitivity to the errors.

12. The method of claim 11, wherein each of the first processed information and the second processed information is independent of the OPD.

13. The method of claim 12, wherein the first processed information, the second processed information, or the information about the test object is any of a relative height map, a film thickness map, or a surface profile.

14. The method of claim 11, wherein the only interferometry signals processed by electronic processor are those from the interferograms measured by the first and second detectors.

15. The method of claim 11, wherein providing the light beam comprises: providing an input beam from the common source; and
separating the input beam into the test light and the reference light.

16. The method of claim 15, further comprising:
directing the test light through a first polarization filter towards the test object; and
transmitting the reference light through a second polarization filter toward a reference object, wherein the test light and the reference light have approximately the same intensity and opposite polarizations prior to reaching the first polarization filter and the second polarization filter, respectively, the test light and the reference light are orthogonally polarized with respect to each other after passing through the first and second polarization filters, and the test light reflects off the test object and the reference light reflects off the reference object;
combining the reflected test light and the reflected reference light to provide combined light;
transmitting the combined light through an optical component, wherein the optical element is configured to alter a polarization state of the combined light; and
directing a first portion of the combined light through a third polarization filter toward the first detector to produce a first interferogram of the two phase-shifted interferograms, and directing a second portion of the combined light through a fourth polarization filter toward the second detector to produce a second interferogram of the two phase-shifted interferograms.

17. The method of claim 15, wherein the test light and the reference light have the same polarization state, the method further comprising
transmitting the test light through a first optical component and through a first polarization filter so as to reflect off the test object, and receiving the reflected test light back through the first optical component and the first polarization filter, wherein the first optical component is configured to alter a polarization state of the test light;
transmitting the reference light through a second optical component and \a second polarization filter so as to reflect off the reference object, and receiving the reflected reference light back through the second optical component and the second polarization filter, wherein the second optical component is configured to alter a polarization state of the reference light;
combining the reflected test light and the reflected reference light to produce combined light; and
directing a first portion of the combined light through a third polarization filter toward the first detector to produce a first interferogram of the two phase-shifted interferograms, and directing a second portion of the combined light through a fourth polarization filter toward the second detector to produce a second interferogram of the two phase-shifted interferograms.

18. The method of claim 15, further comprising:
transmitting the test light through a first optical component so as to reflect off the test object, and receiving the reflected test light back through the first optical component, wherein the first optical component is configured to alter a polarization state of the test light;
transmitting the reference light through a second optical component so as to reflect off a reference object, and receiving the reflected reference light back through the second optical component, wherein the second optical component is configured to alter a polarization state of the reference light;
combining the reflected test light and the reflected reference light into combined light; and
directing a first portion of the combined light through a first polarization filter to the first detector to produce a first interferogram of the two phase-shifted interferograms, and directing a second portion of the combined light through a second polarization filter to the second detector to produce a second interferogram of the two phase-shifted interferograms.

19. The method of claim 15, wherein separating the input beam into the test light and the reference light comprises passing the input beam into a polarizing beam-splitter such that the test light and the reference light are orthogonally polarized with respect to one another, and wherein the method further comprises:
transmitting the test light through a first optical component so as to reflect off the test object, and receiving the reflected test light back through the first optical component, wherein the first optical component is configured to alter a polarization state of the test light;
transmitting the reference light through a second optical component so as to reflect off a reference object, and receiving the reflected reference light back through the second optical component, wherein the second optical component is configured to alter a polarization state of the reference light;
combining the reflected test light and the reflected reference light into combined light;
transmitting the combined light through a third optical component, wherein the third optical component is configured to alter a polarization state of the combined light; and
directing a first portion of the combined light through a first polarization filter to the first detector to produce a first interferogram of the two phase-shifted interferograms, and directing a second portion of the combined light through a second polarization filter to the second detector to produce a second interferogram of the two phase-shifted interferograms.

20. The method of claim 15, wherein separating the input beam into the test light and the reference light comprises passing the input beam into a polarizing beam-splitter such that the test light and the reference light are orthogonally polarized with respect to one another, and wherein the method further comprises:
transmitting the test light through a first optical component so as to reflect off the test object, and receiving the reflected test light back through the first optical component, wherein the first optical component is configured to alter a polarization state of the test light;
transmitting the reference light through a second optical component so as to reflect off a reference object, and receiving the reflected reference light back through the second optical component, wherein the second optical component is configured to alter a polarization state of the reference light;
combining the reflected test light and the reflected reference light into combined light; and
directing a first portion of the combined light through a first polarization filter to the first detector to produce a first interferogram of the two phase-shifted interferograms, and directing a second portion of the combined light through a second polarization filter and through a third optical component to the second detector to produce a second interferogram of the two phase-shifted interferograms, wherein the third optical component is configured to alter a polarization state of the second portion.

21. The method of claim 15, wherein separating the input beam into the test light and the reference light comprises passing the input beam into a polarizing beam-splitter such that the test light and the reference light are orthogonally polarized with respect to one another, and wherein the method further comprises:
directing the test light toward the test object and directing the reference light towards the reference object, wherein the test light reflects off the test object, and the reference light reflects off the reference object;
combining the reflected test light and the reflected reference light in the polarizing beam-splitter to provide combined light;
passing the combined light through an optical component configured to alter polarization state of the combined light;
directing a first portion of the combined light through a first polarization filter to the first detector to provide a first interferogram of the two phase-shifted interferograms; and
directing a second portion of the combined light through a second polarization filter to the second detector to provide a second interferogram of the two phase-shifted interferograms.

22. The method of claim 11, comprising translating a measurement scan position of the test object or a reference object relative to one another to obtain the series of intensity values corresponding to the sequence of OPDs, each intensity value of every interferometry signal being measured at a different measurement scan position.

23. The method of claim 22, wherein using the electronic processor to process the first set of interferometry signals and to process the second set of interferometry signals comprises fitting a function to each interferometry signal, the function being parameterized by one or more parameter values.

24. The method of claim 23, wherein the function is expressible as comprising a plurality of intensity values for corresponding virtual scan positions, the virtual scan positions being defined relative to the measurement scan positions, and wherein, for each interferometry signal, fitting the function comprises:
applying a series of shifts to the virtual scan positions relative to the measurement scan positions;
evaluating the function for each of the series of shifts in the virtual scan positions; and
comparing a degree of similarity between each evaluated function and the corresponding interferometry signal.

25. The method of claim 23, wherein evaluating the function further comprises varying one or more of the parameters for each of the series of shifts in the virtual scan positions, and calculating the intensity values of the function based on the one or more varied parameters.

26. The method of claim 25, wherein the one or more parameter values comprises a phase value, an average magnitude value, and an offset value.

27. The method of claim 25, wherein comparing a degree of similarity between each evaluated function and the corresponding interferometry signal comprises determining which of the series of shifts in the virtual scan positions produce an optimum fit between the function and the corresponding interferometry signal.

28. The method of claim 27, wherein determining which of the series of shifts in the virtual scan positions produces the optimum fit comprises applying a window function to the different measurement and virtual scan positions being evaluated.
